(19) United States
(12) Patent Application Publication
(10) Pub. No.: US 2026/0274492 A1
(43) Pub. Date: Sep. 17, 2026

(54) LABEL AFFIXING DEVICE

(71) Applicant: BROTHER KOGYO KABUSHIKI KAISHA, Nagoya (JP)

(72) Inventors: Shota IIJIMA, Nagoya (JP); Yoshimi IWAMOTO, Nagoya (JP); Akihiro OSADA, Okazaki (JP)

(21) Appl. No.: 19/672,200

(22) Filed: May 8, 2026

Related U.S. Application Data
(63) Continuation of application No. PCT/JP2024/034045, filed on Sep. 25, 2024.

(30) Foreign Application Priority Data
Nov. 17, 2023 (JP) 2023-196037
Nov. 17, 2023 (JP) 2023-196039

(51) Int. Cl. B65C 9/00; B65C 3/02; B65C 9/18

(52) U.S. Cl. CPC B65C 9/0006; B65C 3/02; B65C 9/1865; B65C 2009/0009

(57) ABSTRACT

A label affixing device includes a peeling member and a winding portion. The winding portion winds the release material after the label, to be affixed to an adherend, has been peeled off by the peeling member. The winding portion includes a reel to wind the release material onto an outer peripheral surface. The reel includes an opening extending through the outer peripheral surface, and includes an advancing/retracting member moving between an extended position where the advancing/retracting member is disposed inside the opening and a retracted position where the advancing/retracting member retracts further inward in a radial direction than the extended position. When the winding portion winds the release material, the advancing/retracting member is disposed at the extended position, and when a roll on which the release material is wound is to be removed from the winding portion, the advancing/retracting member is disposed at the retracted position.

### REFERENCE TO RELATED APPLICATIONS

This application is a Continuation Application of International Application No. PCT/JP2024/034045, filed September 25, 2024. This application claims priority from JP2023-196037, filed November 17, 2023 and JP2023-196039 filed November 17, 2023, the entire disclosures of which are incorporated herein by reference there.

### TECHNICAL FIELD

The present disclosure relates to a label affixing device that affixes a label to an adherend.

### BACKGROUND ART

A label affixing device that affixes a label to an adherend is conventionally known. The label affixing device fully peels the label from a release material, and conveys the label to a support portion. The label is disposed horizontally on the support portion with an adhesive surface of the label oriented upward.

A cable comes into contact with the label, from above, in the course of being guided downward toward an affixing mechanism by a guide member. The adhesive surface of the label is affixed to a part of the cable. The cable is inserted into the affixing mechanism together with the label. The affixing mechanism winds the label onto the cable and affixes the label to the cable. The release material is discharged to the outside from a discharge opening at an upper end portion of a housing.

### SUMMARY

In order to reduce time and effort required to process the release material, consideration is given to providing a winding portion configured to wind the release material onto a cylindrical member. In this case, in order to prevent an end portion of the release material from becoming detached at a time of starting the winding, the end portion of the release material is fixed to the cylindrical member. When replacing the label, in order to remove the roll of the wound up release material from the cylindrical member, it is necessary to unwind the roll of the material and release the fixing of the end portion, thus requiring time and effort.

An object of the present disclosure is to provide a label affixing device in which a roll of a release material can be easily removed from a winding portion.

According to a first aspect of the present disclosure, a label affixing device is provided that includes a peeling member, a winding portion, and a first drive power source. The peeling member is configured to peel a label from a long release material supporting the label to be affixed to an adherend. The first drive power source is configured to generate a driving force to drive the winding portion. The winding portion is configured to wind the release material subsequent to the label that has been peeled therefrom by the peeling member. The winding portion includes a reel and a rotation shaft. The reel is configured to wind the release material onto an outer peripheral surface. The reel includes an opening extending through the outer peripheral surface. The rotation shaft rotatably supports the reel. The reel further includes an advancing/retracting member that is configured to be movable between an extended position and a retracted position. The extended position is a position where the advancing/retracting member is disposed inside the opening and where a shortest length in a peripheral direction of the outer peripheral surface at a section including the opening is a first peripheral length. The retracted position is a position where the advancing/retracting member retracts further inward in a radial direction than the extended position and where the shortest length in the peripheral direction is a second peripheral length shorter than the first peripheral length. When the winding portion winds the release material, the advancing/retracting member is disposed at the extended position. When a roll on which the release material is wound is to be removed from the winding portion, the advancing/retracting member is disposed at the retracted position.

The winding portion can wind the release material by winding the release material from which the label has been peeled onto the reel. At the time of winding, the winding portion performs the winding in a state in which the advancing/retracting member is disposed at the extended position. After the winding is complete, by disposing the advancing/retracting member at the retracted position, the winding portion can have a gap between the roll of the release material and the outer peripheral surface of the reel. In this way, a user can easily remove the roll from the reel without unwinding the roll.

Here, the known label affixing devices described above has a configuration in which the cable is clamped between bent portions of a first arm member and a second arm member, and a label is affixed to the cable by rotating the arm members. The bent portions have a shape bulging in a radial direction of the cable in a side view. Thus, when affixing the label to the cable that is narrower than an inner diameter of the bent portions, it is difficult to hold the cable between the bent portions. Thus, wrapping of the label regardless of the thickness of the cable is preferred.

Here, according to a second aspect of the present disclosure, a label affixing device is provided that includes a wrapping portion and a housing. The wrapping portion is configured such that an adherend, to which an end portion of a label serving as an affixing target is affixed, is inserted into the wrapping portion, and is configured to rotate due to a driving force transmitted from a second drive power source and to wrap and affix the label around a periphery of the adherend. The housing is configured to rotatably support the wrapping portion. The wrapping portion includes a first pressing member, a second pressing member, a rotation body, a first urging member, and a second urging member. The first pressing member includes a first pressing surface. The first pressing surface is a flat surface along an insertion direction in which the adherend is inserted toward an insertion position of the adherend. The first pressing surface is oriented toward the insertion position in one direction, with respect to the insertion position, in a direction intersecting the insertion direction. The first pressing member uses the first pressing surface to press the label toward the adherend when the adherend is positioned at the insertion position. The second pressing member includes a second pressing surface. The second pressing surface is a flat surface along the insertion direction. The second pressing surface is oriented toward the insertion position in the other direction, with respect to the insertion position, in the direction intersecting the insertion direction. The second pressing surface faces the first pressing member. The second pressing member uses the second pressing surface to press the label toward the adherend when the adherend is positioned at the insertion position. The rotation body is configured to internally hold the first pressing member and the second pressing member, and to rotate around the insertion position. The first urging member is disposed between an inner surface of the rotation body and the first pressing member. The first urging member is configured to urge the first pressing member in a direction causing the first pressing surface to approach the second pressing surface with the insertion position interposed between the first pressing surface and the second pressing surface. The second urging member is disposed between the inner surface of the rotation body and the second pressing member. The second urging member is configured to urge the second pressing member in a direction causing the second pressing surface to approach the first pressing surface with the insertion position interposed between the first pressing surface and the second pressing surface.

The first pressing member and the second pressing member are respectively urged by the first urging member and the second urging member in the directions in which the first pressing surface and the second pressing surface approach each other. Thus, the first pressing member and the second pressing member can clamp and press the adherend, using the first pressing surface and the second pressing surface, regardless of the outer diameter of the adherend inserted into the insertion position. The first pressing member and the second pressing member clamp the adherend inserted into the insertion position between the first pressing surface and the second pressing surface, and rotate in this state around the insertion position together with the rotation body. In this way, the first pressing member and the second pressing member maintain a contact state of the first pressing surface and the second pressing surface even when the outer diameter of the adherend varies, and can wrap and affix the label to the adherend. Thus, according to the second aspect, the label affixing device can be provided that can wrap and affix the label regardless of the size of the adherend.

### BRIEF DESCRIPTION OF DRAWINGS

FIG. 1 is a perspective view of a label affixing device.

FIG. 2 is a perspective cross-sectional view of the label affixing device cut along a line I-I shown in FIG. 1.

FIG. 3 is a cross-sectional view of the label affixing device as seen from the right when cut along the line I-I shown in FIG. 1.

FIG. 4 is an enlarged view of a section indicated by a two-dot chain line shown in FIG. 3.

FIG. 5 is an enlarged view of a section indicated by a two-dot chain line shown in FIG. 4.

FIG. 6 is a perspective view of a cutting portion.

FIG. 7 is a perspective view of a main unit.

FIG. 8 is a perspective view of the main unit when an opening/closing member is open.

FIG. 9 is an exploded perspective view of the main unit as seen from above right and from the front.

FIG. 10 is an exploded perspective view of the main unit as seen from above left and from the front.

FIG. 11 is a cross-sectional view of the main unit as seen from the right when cut along a line II-II shown in FIG. 7.

FIG. 12 is a perspective view of a moving member as seen from above.

FIG. 13 is a perspective view of the moving member as seen from below.

FIG. 14 is an enlarged view of a section indicated by a two-dot chain line shown in FIG. 11.

FIG. 15 is an enlarged view of a pressing portion when a cable has entered into a guide path.

FIG. 16 is an enlarged view of the pressing portion when the cable has reached a furthermost downstream position at a guide surface.

FIG. 17 is an enlarged view of the pressing portion when the cable has reached a position.

FIG. 18 is an enlarged view of the pressing portion when the cable has moved along an inclined surface.

FIG. 19 is an enlarged view of a section indicated by a two-dot chain line shown in FIG. 11.

FIG. 20 is a perspective view of a wrapping portion.

FIG. 21 is an exploded perspective view of the wrapping portion.

FIG. 22 is a cross-sectional view of the main unit as seen from the right when cut along a line III-III shown in FIG. 7.

FIG. 23 is a cross-sectional enlarged view of the wrapping portion when the cable has reached a wrapping position.

FIG. 24 is a cross-sectional enlarged view of the wrapping portion in a state in which a rotation body has rotated.

FIG. 25 is an exploded perspective view of a winding portion.

FIG. 26 is a cross-sectional view in an axial direction of the winding portion when an operation portion is at a first position.

FIG. 27 is a cross-sectional view in the axial direction of the winding portion when the operation portion is at a second position.

FIG. 28 is a right side view of the winding portion when the operation portion is at the first position.

FIG. 29 is a right side view of the winding portion when the operation portion is at the second position.

FIG. 30 is a cross-sectional view, as seen from the right, of the main unit showing a photosensor according to a modified example that detects a home position of the rotation body.

### DESCRIPTION

An embodiment of a label affixing device 1 embodying the present disclosure will be described with reference to the drawings. The referenced drawings are used to illustrate technological features that can be adopted by the present disclosure. Configurations of devices, for example, described herein are not intended to be limited by the foregoing, and are simply explanatory examples.

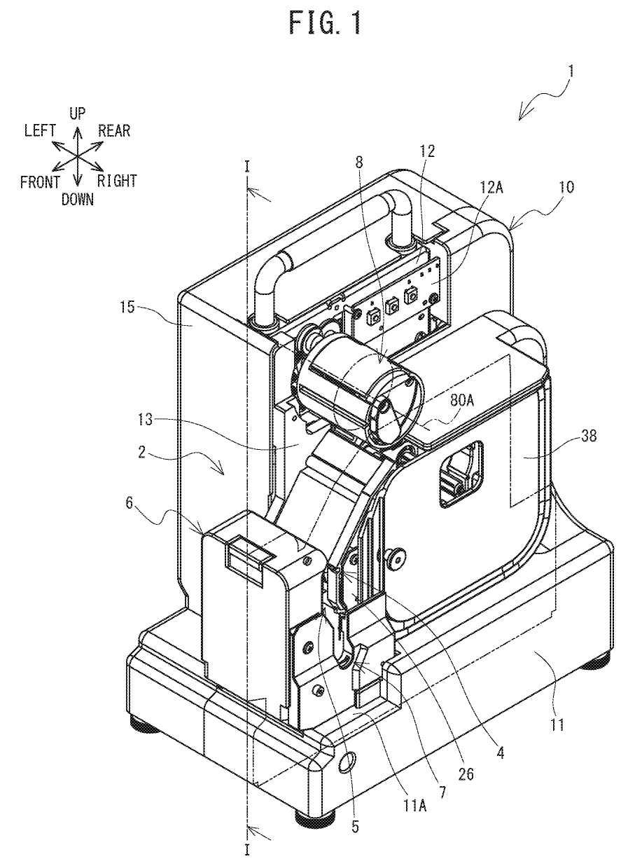

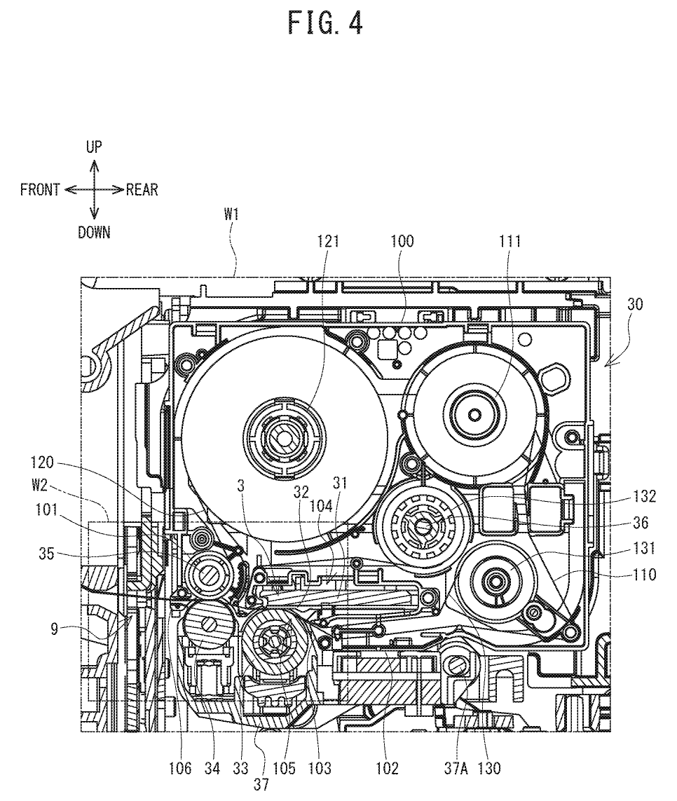

The label affixing device 1 is a device for producing a label 160 by performing printing on a tape 150 of a tape cassette 100 (refer to FIG. 4). Further, the label affixing device 1 is a device for wrapping the produced label 160 around a cable 19 and affixing the label 160 to the cable 19. Hereinafter, a lower left direction, an upper right direction, an upper left direction, a lower right direction, an upward direction, and a downward direction in FIG. 1 are, respectively, a front direction, a rear direction, a left direction, a right direction, an upward direction, and a downward direction of the label affixing device 1.

### Overview of label affixing device 1

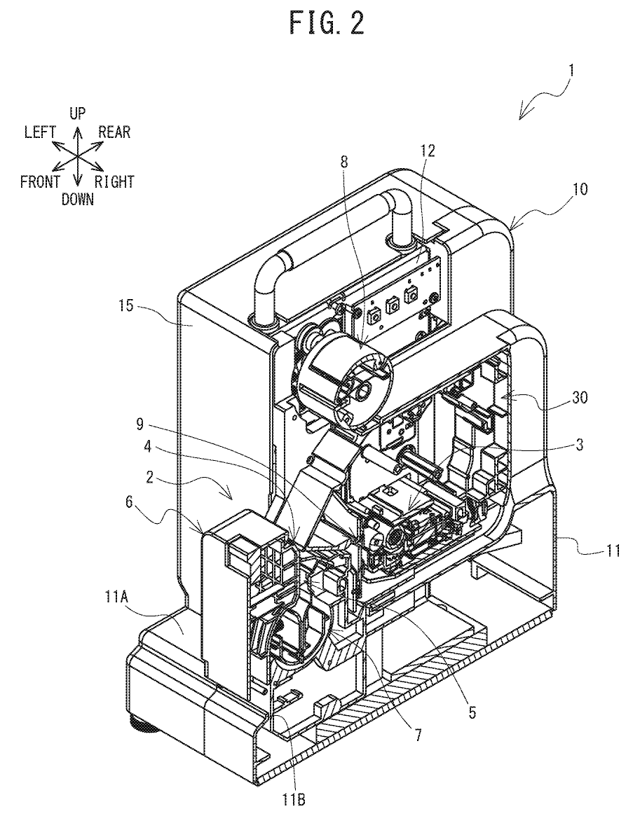

The label affixing device 1 will be described. As shown in FIGS. 1 to 3, the label affixing device 1 includes a box-shaped housing 10. The housing 10 includes a base 11, a main unit 2, a main plate 12, a cover 15, a tape compartment 30, a print portion 3, and a cutting portion 9.

The base 11 is a foundation of the label affixing device 1. The base 11 is a rectangular box shape, and includes adjustable legs, at a bottom portion of the base 11, that maintain the label affixing device 1 in a horizontal posture when the label affixing device 1 is placed on a table, for example. A power supply board, a battery, for example are housed inside the base 11. The base 11 includes a low floor portion 11A at the front end of the base 11.

The low floor portion 11A is lower, in a stepwise manner, than other portions of the base 11. The low floor portion 11A includes a recess portion 11B. The recess portion 11B is a section from substantially the center in the left-right direction to the right end of the low floor portion 11A. The main unit 2 is disposed in the recess portion 11B.

The main unit 2 is a unit for peeling the label 160 from the tape 150 printed in the print portion 3 (to be described later), and for wrapping the label 160 around the cable 19. The main unit 2 includes a peeling member 4, a pressing portion 5, an opening/closing member 6, and a wrapping portion 7. The lower end portion of the main unit 2 is disposed in the recess portion 11B of the low floor portion 11A of the base 11, and is fixed to the base 11. The main unit 2 will be described later.

The main plate 12 has a plate shape extending in the up-down direction and the front-rear direction, is disposed at a position further to the left than the center, in the left-right direction, of the base 11, and extends upward. The lower end portion of the main plate 12 is fixed to the lower end portion of the main unit 2, inside the base 11. The right surface of the main plate 12 supports the tape compartment 30, the print portion 3, the cutting portion 9, a winding portion 8 (to be described later), and an operation panel 12A, and the left surface of the main plate 12 supports a controller and a drive portion (to be described later).

The controller controls operations of the label affixing device 1. The drive portion drives the print portion 3 and the cutting portion 9. The operation panel 12A is fixed to the upper end portion of the main plate 12. The operation panel 12A includes a plurality of buttons for receiving input of operations with respect to the label affixing device 1.

The upper end of the main plate 12 includes a handle for carrying the label affixing device 1. The cover 15 that protects the controller and the drive portion is mounted to the left surface of the main plate 12.

The tape compartment 30 is disposed at substantially the center, in the front-rear direction and the up-down direction of the housing 10, at the right surface of the main plate 12. As shown in FIG. 4, the tape compartment 30 has a box shape whose right surface is open. The tape compartment 30 can accept a plurality of types of tape cassette, such as a thermal type, a receptor type, a laminate type, for example. The thermal-type tape cassette includes a heat-sensitive paper tape. The receptor-type tape cassette includes a tape and an ink ribbon.

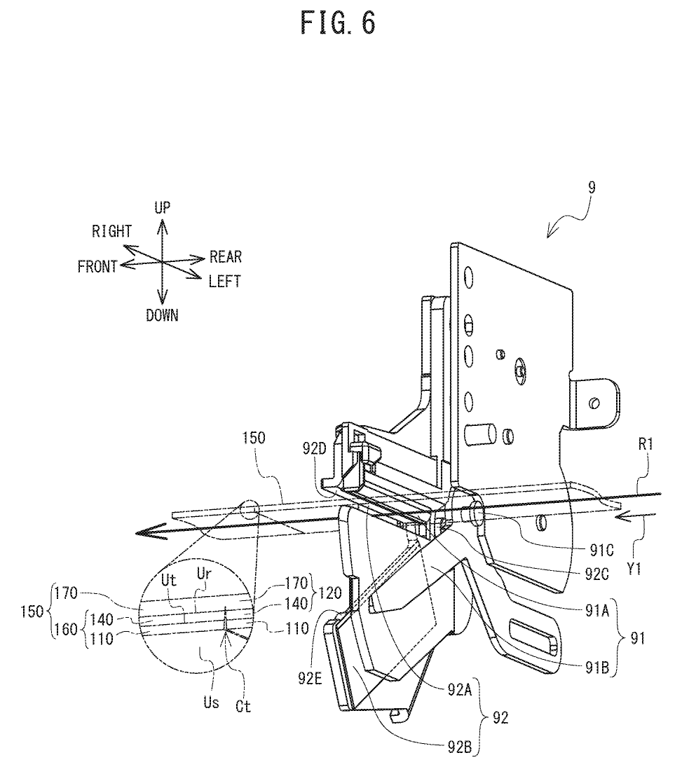

The tape cassette used in the label affixing device 1 according to the present embodiment is the laminate-type tape cassette 100. The laminate-type tape cassette 100 includes a film tape 110, a double-sided adhesive tape 120, and an ink ribbon 130. The film tape 110 is a transparent or semi-transparent PET tape. The double-sided adhesive tape 120 is a tape in which a base material 140 and a release material 170 (refer to FIG. 6) are laminated via an adhesive. The tape cassette 100 will be described later.

### Print portion 3

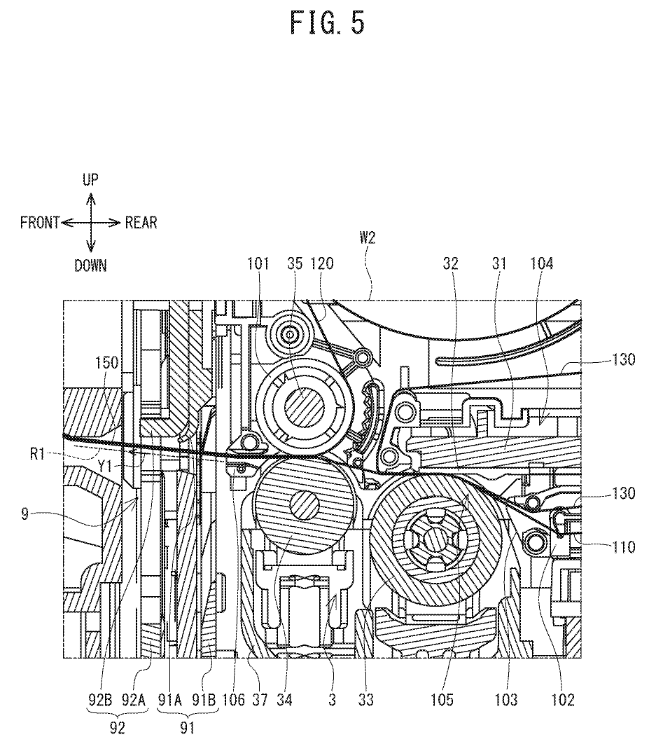

As shown in FIGS. 4 and 5, the print portion 3 is disposed below the tape compartment 30. The print portion 3 includes a head holder 31, a thermal head 32, a drive shaft 35, a winding shaft 36, a platen roller 33, and a conveyance roller 34. The head holder 31 is disposed below the tape compartment 30. The head holder 31 has a plate shape, and extends in the front-rear direction and the left-right direction.

The thermal head 32 is disposed at the lower surface of the head holder 31. The thermal head 32 includes a plurality of heating elements. The plurality of heating elements is aligned in a row in the left-right direction. The thermal head 32 heats the ink ribbon 130 using the plurality of heating elements, and transfers ink to the film tape 110. The head holder 31 supports the thermal head 32 and also functions as a heat sink for the heating elements.

The drive shaft 35 is disposed diagonally below and to the front of the head holder 31. The drive shaft 35 extends to the right from the bottom surface of a recess portion of the tape compartment 30. The drive shaft 35 is driven to rotate by a conveyance motor, and is used to convey the tape 150. When the tape cassette 100 is installed, the drive shaft 35 engages with a shaft hole of a drive roller 101 of the tape cassette 100.

The winding shaft 36 is disposed diagonally above and to the rear of the head holder 31. The winding shaft 36 is driven to rotate by the driving of the conveyance motor. When the tape cassette 100 is installed, the winding shaft 36 engages with a winding spool 132 of the tape cassette 100.

A platen holder 37 is disposed below the head holder 31. The platen holder 37 has an arm shape, and is supported to be rotatable around a support shaft 37A extending in the left-right direction. The support shaft 37A is disposed at the rear end of the platen holder 37.

The platen roller 33 and the conveyance roller 34 are rotatably supported at the leading end portion of the platen holder 37. The platen roller 33 approaches and moves away from the thermal head 32, in accordance with swinging of the platen holder 37. The conveyance roller 34 is disposed to the left of the platen roller 33. The conveyance roller 34 approaches and moves away from the drive roller 101 of the tape cassette 100, in accordance with the swinging of the platen holder 37.

A cassette cover 38 (refer to FIG. 1) is rotatably supported at the rear end portion of the tape compartment 30. A rotation center of the cassette cover 38 extends in the up-down direction. The cassette cover 38 opens and closes an open section of the tape compartment 30.

In conjunction with the opening and closing of the cassette cover 38, the platen holder 37 swings between a stand-by position and a printing position. When the cassette cover 38 is opened, the platen holder 37 moves to the stand-by position. The stand-by position is a position at which the platen roller 33 and the conveyance roller 34 are separated from the tape compartment 30. When the platen holder 37 has moved to the stand-by position, a user can install the tape cassette 100 into the tape compartment 30, or can remove the tape cassette 100 from the tape compartment 30.

When the cassette cover 38 is closed, the platen holder 37 moves to the printing position. The printing position is a position at which the platen roller 33 and the conveyance roller 34 are closer to the tape compartment 30. At the printing position, the platen roller 33 presses the film tape 110 and the ink ribbon 130 against the thermal head 32. At the printing position, the conveyance roller 34 overlaps the double-sided adhesive tape 120 and the film tape 110, and presses them against the drive roller 101.

The tape cassette 100 houses the film tape 110, the double-sided adhesive tape 120, and the ink ribbon 130 in a box-shaped case. A film spool 111 is rotatably supported at a position diagonally upward and to the rear inside the case. The film tape 110 before printing is wound around the film spool 111. A ribbon spool 131 is rotatably supported at a position diagonally downward and to the rear inside the case. The unused ink ribbon 130 is wound around the ribbon spool 131.

A tape spool 121 is rotatably supported at a position diagonally upward and to the front inside the case. The double-sided adhesive tape 120 is wound around the tape spool 121. The winding spool 132 is rotatably supported at a position between the film spool 111, the tape spool 121, and the ribbon spool 131. The used ink ribbon 130 is wound on the winding spool 132. The drive roller 101 is rotatably supported at a position diagonally below and to the front of the tape spool 121 inside the case.

An arm portion 102 is disposed at the lower portion of the case. The arm portion 102 extends from the lower rear portion of the case to the lower front portion of the case. An opening 103 is disposed at the left end of the arm portion 102. The opening 103 has a slit shape extending in the left-right direction. The film tape 110 and the ink ribbon 130 are overlaid with each other inside the case, and are discharged from the opening 103.

A head insertion portion 104 is disposed above the arm portion 102. The head insertion portion 104 extends through the case in the up-down direction. A head opening 105 that is open downward is disposed at the front lower portion of the head insertion portion 104. The head opening 105 is positioned downstream of the opening 103 in a conveying direction of the film tape 110, namely, is positioned to the front of the opening 103. In a state in which the tape cassette 100 is installed in the tape compartment 30, the head holder 31 is inserted into the head insertion portion 104.

The drive roller 101 is positioned to the front of the head insertion portion 104. In the conveying direction of the film tape 110, the drive roller 101 is positioned between the opening 103 of the arm portion 102 and a guide portion 106. The drive roller 101 has a cylindrical shape and extends in the left-right direction. The lower end portion of the drive roller 101 is exposed downward from the case. The drive roller 101 supports the double-sided adhesive tape 120 in a state in which the film tape 110 and the double-sided adhesive tape 120 are overlaid with each other.

In the state in which the tape cassette 100 is installed in the tape compartment 30, the drive shaft 35 is inserted into the shaft hole of the drive roller 101. The film tape 110 and the double-sided adhesive tape 120 are clamped between the drive roller 101 and the conveyance roller 34. The drive roller 101 rotates in accordance with the rotational driving of the drive shaft 35 and conveys the film tape 110 and the double-sided adhesive tape 120.

The guide portion 106 is disposed at a corner portion diagonally downward and at the front of the case. The guide portion 106 is disposed downstream of the opening 103 in the conveying direction of the film tape 110, namely, is positioned to the front of the opening 103. The guide portion 106 has a slit shape extending in the left-right direction.

The tape 150, which is formed by the double-sided adhesive tape 120 being adhered to the film tape 110, is conveyed by the drive roller 101 and passes through the inside of the guide portion 106. The guide portion 106 supports the tape 150 from both sides in the width direction. In this way, the tape 150 is discharged from the tape cassette 100 in a state in which the posture of the tape 150 is held by the guide portion 106.

At the time of printing, the platen holder 37 moves from the stand-by position to the printing position. The platen roller 33 presses the film tape 110 and the ink ribbon 130 in the overlaid state against the thermal head 32. The platen roller 33 rotates and conveys the film tape 110 toward the front. At the same time, the thermal head 32 produces heat, and the ink ribbon 130 is heated.

In this way, the ink of the ink ribbon 130 is transferred to a print surface Ut (refer to FIG. 6) of the film tape 110. As a result of the transfer, an image including characters, for example is printed on the film tape 110. After the printing, the ink ribbon 130 separates from the film tape 110, and is wound by the winding spool 132.

The double-sided adhesive tape 120 is overlaid with the print surface Ut of the film tape 110 that has been printed. The base material 140 of the double-sided adhesive tape 120 comes into contact with the print surface Ut of the film tape 110. The film tape 110 is disposed below the double-sided adhesive tape 120. In this state, the film tape 110 and the double-sided adhesive tape 120 pass between the drive roller 101 and the conveyance roller 34. The film tape 110 is adhered to the base material 140 using adhesive, and the printed label 160 (refer to FIG. 6) is produced.

The upper surface of the label 160 corresponds to an adhesive surface Ur (refer to FIG. 6) to which the adhesive of the base material 140 is adhered. A state is obtained in which the release material 170 is adhered to the adhesive surface Ur. In other words, as a result of the double-sided adhesive tape 120 being adhered to the film tape 110, the tape 150 is produced in a state in which the release material 170 is adhered to the label 160.

A width direction of the tape 150 corresponds to the left-right direction. A conveying path of the tape 150 that is conveyed from the print portion 3 to the main unit 2 while passing through the cutting portion 9 will be referred to as a conveying path R1. A conveying direction of the tape 150 along the conveying path R1 will be referred to as a conveying direction Y1. The conveying direction Y1 is a direction from a nip point between the drive roller 101 and the conveyance roller 34 toward the main unit 2, passing through the cutting portion 9, and is a direction toward the front.

### Cutting portion 9

As shown in FIGS. 5 and 6, the cutting portion 9 is disposed downstream of the conveyance roller 34 of the print portion 3 in the conveying direction Y1 of the tape 150. The cutting portion 9 includes a full-cut cutting blade 91 and a half-cut cutting blade 92. The full-cut cutting blade 91 includes a fixed blade 91A and a movable blade 91B. The fixed blade 91A is fixed at a position higher than the conveying path R1. The fixed blade 91A extends in the left-right direction, and a cutting edge of the fixed blade 91A faces downward.

The movable blade 91B is disposed at a position lower than the conveying path R1. The movable blade 91B has a plate shape extending in the left-right direction, and a cutting edge the movable blade 91B faces upward. The movable blade 91B is supported by a rotation shaft 91C and can rotate. The rotation shaft 91C is disposed to the left of the conveying path R1 and extends in the front-rear direction. The movable blade 91B rotates about the rotation shaft 91C as a result of a driving force of a motor.

The full-cut cutting blade 91 moves the cutting edge of the movable blade 91B upward, through the conveying path R1 from below the conveying path R1, with respect to the cutting edge of the fixed blade 91A. In this way, the full-cut cutting blade 91 cuts the tape 150. In other words, the full-cut cutting blade 91 fully cuts the tape 150.

The half-cut cutting blade 92 is disposed downstream of the full-cut cutting blade 91 on the conveying path R1. The half-cut cutting blade 92 includes a fixed base 92A and a movable blade 92B. The fixed base 92A is fixed above the conveying path R1. The fixed base 92A extends in the left-right direction, and includes a blade contact surface 92D that faces downward, namely, faces toward the conveying path R1.

The movable blade 92B is disposed at a position lower than the conveying path R1. The movable blade 92B has a plate shape extending in the left-right direction. The movable blade 92B is supported by a rotation shaft 92C and can rotate. The rotation shaft 92C is disposed to the left of the conveying path R1 and extends in the front-rear direction. The movable blade 92B rotates about the rotation shaft 92C as a result of a driving force of a motor.

The cutting edge of the movable blade 92B extends in the left-right direction and faces upward. A protrusion 92E is disposed at a leading end portion of the movable blade 92B. The protrusion 92E protrudes slightly higher than the cutting edge of the movable blade 92B. The amount by which the protrusion 92E protrudes above the cutting edge is equal to or less than a thickness of the release material 170.

The tape 150 is conveyed along the conveying path R1 in the state in which the film tape 110 is adhered below the double-sided adhesive tape 120. Thus, of the label 160, the adhesive surface Ur to which the release material 170 is adhered faces upward. A front surface (top surface) Us on the opposite side to the adhesive surface Ur faces downward.

At the time of cutting, in the half-cut cutting blade 92, the cutting edge of the movable blade 92B approaches the blade contact surface 92D of the fixed base 92A. The cutting edge of the half-cut cutting blade 92 cuts the film tape 110 and the base material 140 that are lower than the release material 170, namely, cuts the label 160 from the front surface Us side toward the adhesive surface Ur side. Due to the protrusion 92E, the half-cut cutting blade 92 has a gap between the cutting edge and the blade contact surface 92D, which is equal to or less than the thickness of the release material 170. In this way, the half-cut cutting blade 92 leaves the release material 170 uncut. In other words, the half-cut cutting blade 92 half cuts the tape 150.

### Main unit 2

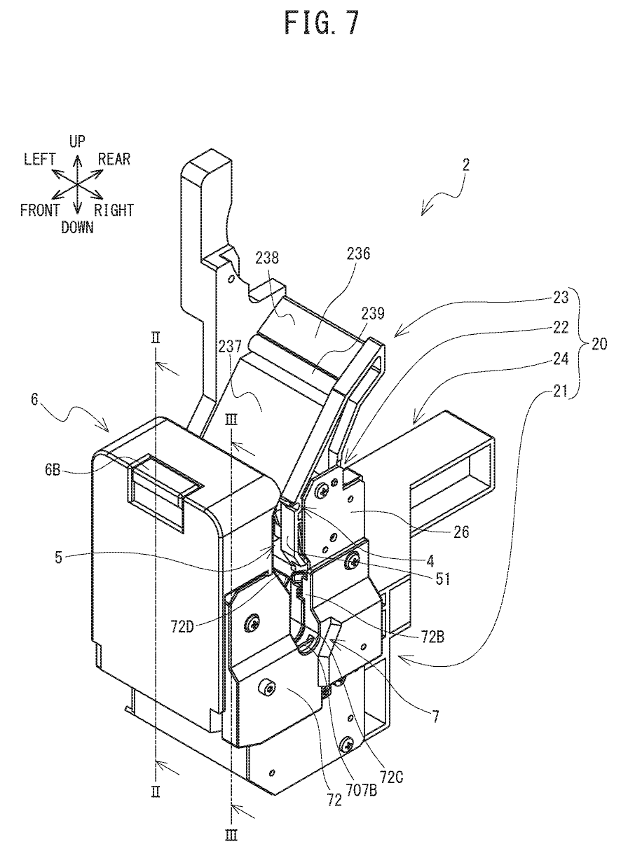

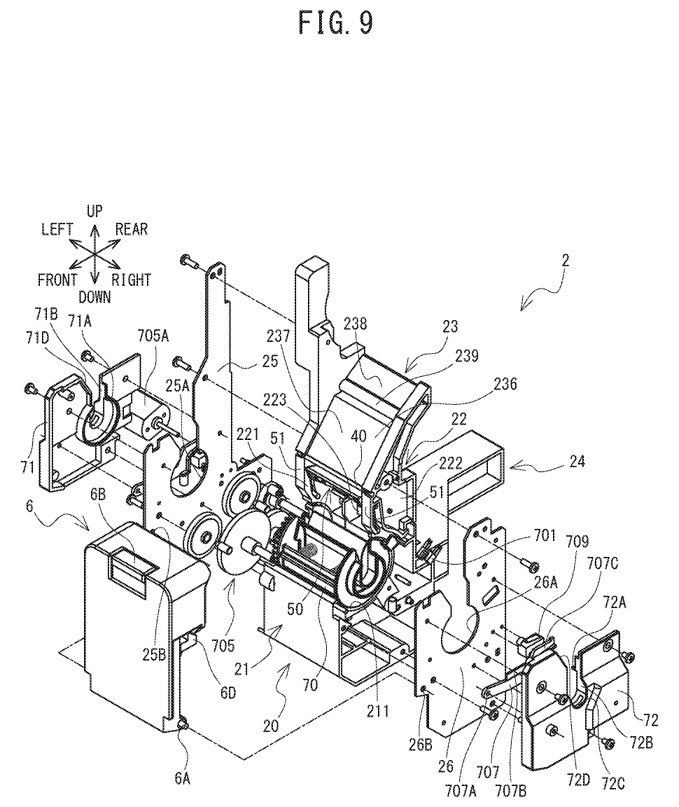

As shown in FIGS. 7 to 11, the main unit 2 is reinforced at both side surfaces of the base body 20 by a left side plate 25 and a right side plate 26 (refer to FIG. 9). The main unit 2 includes the peeling member 4, the pressing portion 5, the opening/closing member 6, and the wrapping portion 7, between the left side plate 25 and the right side plate 26. The base body 20 is made of resin and supports the whole of the main unit 2. The base body 20 includes a bottom portion 21, a middle portion 22, an upper portion 23, and a rear portion 24. The size of the base body 20 in the left-right direction is greater than a maximum width of the tape 150 corresponding to the label affixing device 1, namely, is greater than a maximum width of the label 160.

The bottom portion 21 has a square cylindrical box shape extending in the left-right direction, and includes a partition plate 212, extending in the front-rear direction and the up-down direction, at a center of the bottom portion 21 in the left-right direction. The lower portion of the bottom portion 21 is disposed inside the recess portion 11B of the base 11. A housing portion 211 is disposed at the upper portion of the bottom portion 21. The housing portion 211 has a semi-circular cylindrical shaped recessed surface whose axial direction is the left-right direction and which is open upward and to the front.

The wrapping portion 7 is disposed in the bottom portion 21. The wrapping portion 7 wraps the label 160 around the cable 19. A drive mechanism 705 (refer to FIG. 9) is supported at the right surface of the left side plate 25, and is disposed in a region further to the left than the partition plate 212 inside the bottom portion 21. The drive mechanism 705 transmits a driving force for driving a rotation body 70 of the wrapping portion 7.

A motor 705A is assembled to the left surface of the left side plate 25, and a rotation shaft of the motor 705A passes through the left side plate 25 and is connected to the drive mechanism 705. The motor 705A generates the driving force for driving the rotation body 70. The rotation body 70 is housed in the housing portion 211. The wrapping portion 7 will be described later. The rear portion 24 protrudes to the rear of the bottom portion 21. The rear portion 24 is disposed further to the rear than the recess portion 11B inside the base 11, and is fixed to the base 11 by screws, along with the lower portion of the bottom portion 21.

The middle portion 22 includes a left wall 221, a right wall 222, and a connecting wall 223, and is disposed above the bottom portion 21. The left wall 221 extends upward from the left rear end portion of the bottom portion 21, and the right wall 222 extends upward from the right rear end portion of the bottom portion 21. The connecting wall 223 connects the left wall 221 and the right wall 222 in the left-right direction, at the rear portion of the connecting wall 223.

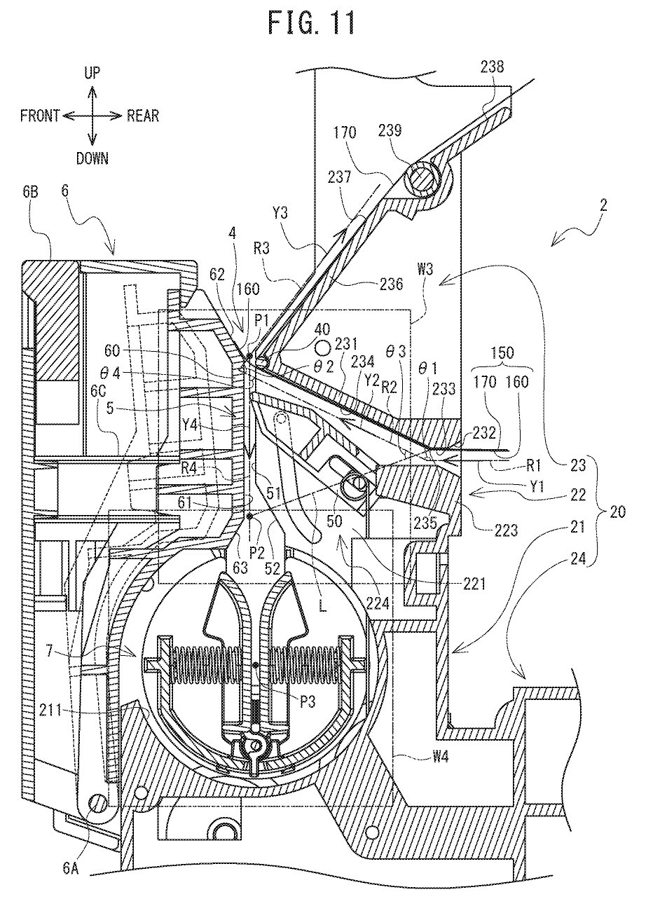

A region between the left wall 221 and the right wall 222 is a peeling region 224 (refer to FIG. 11). The peeling region 224 is a space that is open to the front and downward. The label 160 is pulled downward in the peeling region 224, and is peeled away from the release material 170.

The pressing portion 5 is disposed in the middle portion 22. The pressing portion 5 is a portion that presses an end portion of the label 160 onto the cable 19. Guide surfaces 51 are disposed at the front end of the left wall 221 and the front end of the right wall 222 in the middle portion 22. The guide surfaces 51 are surfaces that extend in the up-down direction and face to the front. The pressing portion 5 and the guide surfaces 51 will be described later.

The upper portion 23 is disposed above the middle portion 22. Each of the left wall 221 and the right wall 222 extends further from the middle portion 22 toward the upper portion 23. As shown in FIG. 11, the upper portion 23 includes a first wall 231 and a second wall 236. The first wall 231 has a plate shape stretching between the left wall 221 and the right wall 222 and extends diagonally upward toward the front in a side view. The second wall 236 has a plate shape stretching between the left wall 221 and the right wall 222 and extends diagonally upward toward the rear in a side view, from the front end of the first wall 231.

The peeling member 4 is disposed at a connection portion of the first wall 231 and the second wall 236. The peeling member 4 will be described later. The first wall 231 defines a furthermost downstream section, in the conveying direction Y1 in the conveying path R1, of the tape 150 that has passed through the cutting portion 9, and defines a conveying path R2 along which the tape 150 is conveyed to the peeling member 4. The conveying path R2 is connected to the conveying path R1.

The first wall 231 includes a first surface 232 and a second surface 233 facing the conveying path R1, and a third surface 234 facing the conveying path R2. The first surface 232 is positioned further downstream, in the conveying direction Y1 of the tape 150 conveyed along the conveying path R1, than the cutting portion 9, and faces diagonally downward to the front. The first surface 232 is disposed at a position at which the tape 150 that has passed through the cutting portion 9 enters into the main unit 2. The second surface 233 is positioned furthermost downstream in the conveying direction Y1 in the conveying path R1, is connected to the first surface 232, and faces downward. The second surface 233 defines the conveying direction Y1 of the tape 150, by coming into contact with the tape 150.

A conveying direction Y2 is a direction along which the tape 150 is conveyed on the conveying path R2 along the third surface 234, and is a direction extending diagonally upward toward the front. The third surface 234 is connected to the second surface 233 at a position furthermost upstream in the conveying direction Y1 of the conveying path R1, extends toward the peeling member 4, and faces diagonally downward to the front. The third surface 234 is in contact with the tape 150 being conveyed along the conveying path R2, defines the conveying direction Y2, and guides the tape 150 toward the peeling member 4.

The second wall 236 defines a conveying path R3 of the release material 170 conveyed toward the winding portion 8. The second wall 236 includes a fourth surface 237 facing the conveying path R3, a fifth surface 238, and a roller 239. The fourth surface 237 is positioned furthermost upstream in a conveying direction Y3 of the release material 170 conveyed along the conveying path R3, and faces diagonally upward to the front. The conveying direction Y3 is a direction along which the tape 150 is conveyed on the conveying path R3 along the fourth surface 237, and is a direction extending upward toward the rear.

The fourth surface 237 is disposed at an entrance of the conveying path R3 along which the release material 170, from which the label 160 has been peeled away at the peeling member 4, is conveyed toward the winding portion 8 positioned diagonally upward and to the rear of the main unit 2. The fourth surface 237 guides the release material 170 along the conveying path R3 to the roller 239.

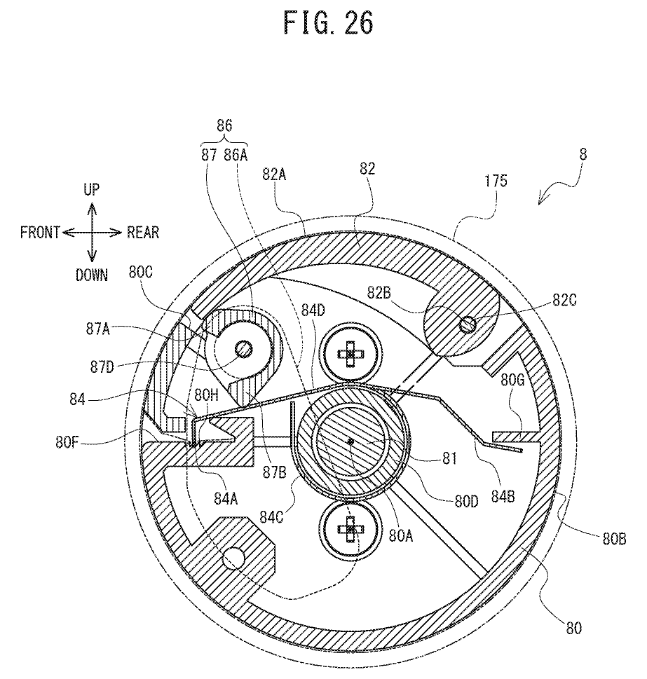

The roller 239 is disposed at a connection portion between the fourth surface 237 and the fifth surface 238. A release material roll 175 (refer to FIG. 26) is a roll of the release material 170 wound onto the winding portion 8, and an outer diameter of the release material roll 175 changes in accordance with a winding amount. The roller 239 adjusts the conveying direction of the release material 170 that has passed the roller 239, in accordance with the changes in the outer diameter of the release material roll 175, thus suppressing breakage of the release material 170. The fifth surface 238 extends diagonally upward to the rear and faces upward at a more moderate angle than the fourth surface 237.

An angle θ1 between the conveying direction Y1 and the conveying direction Y2 is greater than 90 degrees, and less than 180 degrees. The tape 150 on which the image has been printed by the print portion 3 is conveyed on the conveying path R1, toward the cutting portion 9. At this time, the tape 150 is conveyed in a state in which the label 160 is positioned below the release material 170.

The tape 150 is half cut by the cutting portion 9, and the label 160 is cut while leaving the release material 170 intact. The tape 150 is conveyed on the conveying path R2 in a state of being pulled as a result of being wound by the winding portion 8 positioned higher than the peeling member 4. Thus, in the conveying path R2, the tape 150 comes into contact with the second surface 233 positioned lower than the first surface 232, without coming into contact with the first surface 232, and is guided in the conveying direction Y1.

The tape 150 is further guided in the conveying direction Y2 toward the peeling member 4 along the third surface 234. At a connection portion 235 between the second surface 233 and the third surface 234, the tape 150 is bent at an angle greater than 90 degrees and less than 180 degrees. The release material 170 of the tape 150 is closer to the connection portion 235 than the adhesive surface Ur of the base material 140 of the label 160, namely, is above the adhesive surface Ur. Thus, the front surface Us of the label 160 faces downward.

Thus, when a half-cut position Ct passes the connection portion 235 between the second surface 233 and the third surface 234, the tape 150 is bent at an obtuse angle with the release material 170 being disposed further inward than the label 160. As a result, the half-cut position Ct is spread apart. Thus, the end portion of the label 160 is easily peeled away from the release material 170.

As shown in FIGS. 7 to 11, the left side plate 25 is a metal plate that extends in the up-down direction and the front-rear direction. The left side plate 25 is fixed to the left side surface of the base body 20 using screws. When the main unit 2 is fixed to the base 11, the left side plate 25 is disposed at a position substantially at the center of the low floor portion 11A in the left-right direction.

An opening 25A is disposed at the center of the left side plate 25. The opening 25A has a circular shape extending through the left side plate 25 in the left-right direction. An upper end section of an inner periphery of the opening 25A is cut out in the upward direction. The cut out section is connected to an open section cut out of part of the upper end of the left side plate 25.

Of the upper end portion of the left side plate 25, the upper end portion to the rear of the opening 25A extends further upward than the upper end portion to the front. Also, the upper end portion to the rear of the opening 25A extends to be longer and further upward than the upper end portion to the rear of an opening 26A of the right side plate 26. In a state in which the left side plate 25 is assembled to the base body 20, the circular-shaped section of the opening 25A is disposed at a position corresponding to the housing portion 211 of the bottom portion 21.

The right side plate 26 is a metal plate extending in the up-down direction and the front-rear direction. The right side plate 26 is fixed to the right side surface of the base body 20 using screws. When the main unit 2 is fixed to the base 11, the right side plate 26 is disposed at a position toward the right end of the low floor portion 11A. The right side plate 26 faces the left side plate 25 in the left-right direction.

The right side plate 26 is substantially the same shape as the left side plate 25. The opening 26A is disposed at the center of the right side plate 26. The opening 26A has a circular shape extending through the right side plate 26 in the left-right direction. An upper end section of an inner periphery of the opening 26A is cut out in the upward direction. The cut out section is connected to an open section cut out of part of the upper end of the right side plate 26.

Of the upper end portion of the right side plate 26, the upper end portion to the rear of the opening 26A extends further upward than the upper end portion to the front. In a state in which the right side plate 26 is assembled to the base body 20, the circular-shaped section of the opening 26A is disposed at a position corresponding to the housing portion 211 of the bottom portion 21.

A left support portion 71 is fixed to the left surface of the left side plate 25 using screws. The left support portion 71 extends in the up-down direction and the front-rear direction and has a box shape having a thickness in the left-right direction. A stepped shape is formed at substantially the center of the left support portion 71 in the up-down direction. The thickness of the lower portion of the left support portion 71 is thicker than the thickness of the upper portion of the left support portion 71.

A guide portion 71B is provided in the left support portion 71. The guide portion 71B has a substantially U-shape recessed downward from the upper end of the guide portion 71B. A bottom portion 71C of the guide portion 71B has a semicircular shape. The bottom portion 71C includes an opening. An input portion 706B of a lever member 706 is exposed from the opening of the bottom portion 71C.

The guide portion 71B guides the cable 19 to the bottom portion 71C. The bottom portion 71C is a guide position that guides the cable 19 to the left of a wrapping position P3. The wrapping position P3 is a position at which the wrapping portion 7 wraps the label 160 around the cable 19. As a result of being guided to the bottom portion 71C that is the guide position, the cable 19 is disposed at the wrapping position P3 to the right of the bottom portion 71C.

Of the upper end portion of the left support portion 71, a guide surface 71D is disposed at the upper end portion further to the front than the guide portion 71B. The guide surface 71D is an inclined surface facing diagonally upward to the rear, and guides the cable 19 toward the guide portion 71B. When a position of the cable 19, which has passed through a guide path R4 and through the pressing portion 5, is displaced to the front, the cable 19 comes into contact with the guide surface 71D. In this case, the cable 19 is guided to the guide portion 71B along the guide surface 71D, and reaches the wrapping portion 7.

A rotation shaft bearing portion 71A is disposed at the right surface of the left support portion 71. The rotation shaft bearing portion 71A has a substantially C shape protruding to the right along the semicircular bottom portion 71C, in a peripheral direction excluding the guide portion 71B. In a state in which the left support portion 71 is assembled to the left side plate 25, the rotation shaft bearing portion 71A is disposed at the circular shaped section of the opening 25A of the left side plate 25, and protrudes further to the right than the left side plate 25.

A rotation shaft portion 73C of the rotation body 70 of the wrapping portion 7 engages with the rotation shaft bearing portion 71A. The inner surface of the rotation shaft bearing portion 71A rotatably supports the rotation shaft portion 73C. The outer surface of the rotation bearing shaft portion 71A is supported by the circular-shaped section of the opening 25A of the left side plate 25. The rotation shaft portion 73C of the rotation body 70 is supported by both the left support portion 71 and the left side plate 25. Thus, even when the user presses the cable 19 strongly against the rotation body 70, the rotation body 70 is unlikely to become tilted or displaced.

A right support portion 72 is fixed to the right surface of the right side plate 26 using screws. The right support portion 72 extends in the up-down direction and the front-rear direction and has a box shape having a thickness in the left-right direction. A stepped shape is formed at substantially the center of the right support portion 72 in the up-down direction. The thickness of the lower portion of the right support portion 72 is thicker than the thickness of the upper portion of the right support portion 72.

A guide portion 72B is provided in the right support portion 72. The guide portion 72B has a substantially U-shape recessed downward from the upper end of the guide portion 72B. A bottom portion 72C of the guide portion 72B has a semicircular shape. The bottom portion 72C includes an opening. An input portion 707B of a lever member 707 is exposed from the opening of the bottom portion 72C.

The guide portion 72B guides the cable 19 to the bottom portion 72C. The bottom portion 72C is a guide position that guides the cable 19 to the right of the wrapping position P3. As a result of being guided to the bottom portion 72C that is the guide position, the cable 19 is disposed at the wrapping position P3 to the left of the bottom portion 72C.

Of the upper end portion of the right support portion 72, a guide surface 72D is disposed at the upper end portion further to the front than the guide portion 72B. The guide surface 72D is an inclined surface facing diagonally upward to the rear, and guides the cable 19 toward the guide portion 72B. When a movement direction of the cable 19 is displaced to the front, the cable 19 comes into contact with the guide surface 72D. In this case, the cable 19 is guided to the guide portion 72B along the guide surface 72D, and reaches the wrapping portion 7.

A rotation shaft bearing portion 72A is disposed at the left surface of the right support portion 72. The rotation shaft bearing portion 72A has a substantially C shape protruding to the left along the semicircular bottom portion 72C, in a peripheral direction excluding the guide portion 72B. In a state in which the right support portion 72 is assembled to the right side plate 26, the rotation shaft bearing portion 72A is disposed at the circular shaped section of the opening 26A of the right side plate 26, and protrudes further to the left than the right side plate 26.

A rotation shaft portion 74C of the rotation body 70 engages with the rotation shaft bearing portion 72A. The inner surface of the rotation shaft bearing portion 72A rotatably supports the rotation shaft portion 74C of the rotation body 70. The outer surface of the rotation bearing shaft portion 72A is supported by the circular-shaped section of the opening 26A of the right side plate 26. The rotation shaft portion 74C of the rotation body 70 is supported by both the right support portion 72 and the right side plate 26. Thus, even when the user presses the cable 19 strongly against the rotation body 70, the rotation body 70 is unlikely to become tilted or displaced.

### Peeling member 4

The peeling member 4 peels away the label 160 from the release material 170. The peeling member 4 includes a round rod-shaped peeling shaft 40 extending in the left-right direction. A fixing portion for fixing the peeling shaft 40 is disposed at a connection section between the first wall 231 and the second wall 236.

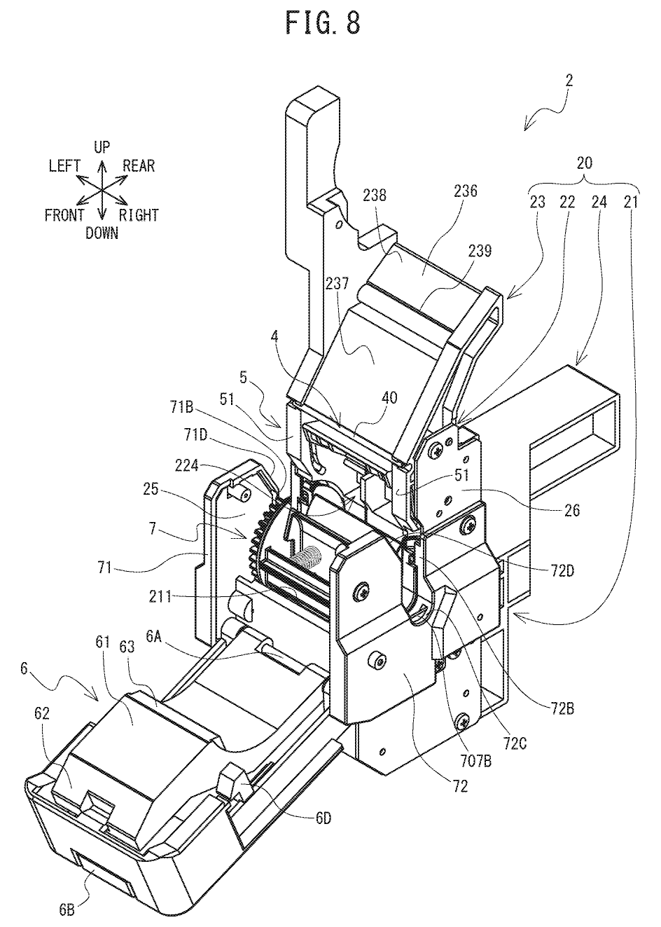

The peeling shaft 40 is disposed at a position furthermost downstream in the conveying direction Y2 along the third surface 234, in the conveying path R2. Also, the peeling shaft 40 is disposed at a position furthermost upstream in the conveying direction Y3 along the fourth surface 237, in the conveying path R3. The peeling shaft 40 is exposed at the guide surfaces 51 of the pressing portion 5 (refer to FIG. 8). The surface of the peeling shaft 40 has a coating layer. The coating layer suppresses the attachment of adhesive when peeling away the label 160.

As shown in FIG. 11, an angle θ2 between the conveying direction Y2 and the conveying direction Y3 is equal to or less than 90 degrees. The tape 150 conveyed on the conveying path R2 reaches the peeling member 4 in a state in which, at the connection portion 235, the label 160 is easily peeled away from the release material 170. As a result of the release material 170 being pulled by the winding portion 8, the tape 150 is bent at the angle equal to or less than 90 degrees in a state in which, at the peeling member 4, the release material 170 is in contact with the peeling shaft 40. Thus, when the half-cut position Ct passes the peeling member 4, the tape 150 is bent at an acute angle or at a right angle with the release material 170 positioned on the inner portion. In the tape 150, the half-cut position Ct is spread apart even more than when passing the connection portion 235. As a result, the end portion of the label 160 is peeled away from the release material 170.

When the release material 170 moves in the conveying direction Y3, the end portion of the label 160 peeled away from the release material 170 moves in the conveying direction Y2. The end portion of the label 160 passes over a support surface 62 of the opening/closing member 6, and is disposed at an affixing position P1 in a state in which the adhesive surface Ur faces upward. The affixing position P1 is a position at which the affixing of the end portion of the label 160 to the cable 19 is performed. The affixing position P1 is a position furthermost upstream in a guide direction Y4. The guide direction Y4 is a direction in which the cable 19 inserted into the guide path R4 of the pressing portion 5 is guided.

At the half cut position Ct of the label 160, the adhesive adhered to the surface of the base material 140 that is the surface adhered to the print surface Ut of the film tape 110 is exposed at a cutting surface. Rollers for conveying the tape 150 are not disposed further downstream in the conveying direction Y1 than the cutting portion 9 in the conveying path R1, nor in the conveying path R2. Thus, on a path from the cutting portion 9 to reaching the peeling member 4, the tape 150 is not pinched at any nip point between rollers.

Further, when the tape 150 passes the connection portion 235, the release material 170 is positioned closer to the connection portion 235 than the label 160. Thus, in the tape 150, the label 160 is bent at a superior angle with respect to the release material 170, and is not bent at an inferior angle. On the path from the cutting portion 9 to reaching the peeling member 4, the tape 150 passes along the conveying paths R1 and R2 having this type of configuration. Thus, at the half-cut position Ct, the adjacent labels 160 are suppressed from being re-adhered by the adhesive exposed at the cutting surface at the cut position Ct.

### Opening/closing member 6

As shown in FIGS. 7 to 11, the opening/closing member 6 has a box shape extending in the up-down direction, and is disposed at the front of the base body 20. The opening/closing member 6 includes a shaft body 6A that extends through the lower end portion of the opening/closing member 6 in the left-right direction, and protrudes in the left and right directions from each of a lower end portion left surface and lower end portion right surface (refer to FIG. 9). The shaft body 6A engages with shaft holes 25B and 26B respectively disposed in the lower front corner portion of the left side plate 25 and the lower front corner portion of the right side plate 26, and rotatably supports the opening/closing member 6.

The opening/closing member 6 includes hooks 6D. The hooks 6D engage with the base body 20, in conjunction with an opening/closing button 6B at an upper front edge portion of the opening/closing member 6. The upper end portion of the opening/closing member 6 rotates to the front when the engagement of the hooks 6D with the base body 20 is released by the depression of the opening/closing button 6B, and is in an open state. In the open state, in the main unit 2, the peeling region 224 of the pressing portion 5 and the housing portion 211 of the wrapping portion 7 are exposed at the front surface of the label affixing device 1 (refer to FIG. 8). In a closed state, in the main unit 2, the peeling region 224 and the housing portion 211 are covered by the opening/closing member 6 (refer to FIG. 7).

The opening/closing member 6 includes a pressing member 60. When the opening/closing member 6 is in the closed state, the pressing member 60 protrudes to the rear at the rear surface of the opening/closing member 6, and advances and retracts in the front-rear direction. The pressing member 60 extends in the up-down direction, and the lower end portion of the pressing member 60 is supported by the shaft body 6A. The upper end portion of the pressing member 60 swings in the front-rear direction, as shown by dotted lines in FIG. 11. The pressing member 60 is urged to the rear by a compression coil spring 6C disposed inside the opening/closing member 6.

The front surface of the pressing member 60 is a pressing surface 61. When the opening/closing member 6 is in the closed state, the pressing surface 61 extends in the up-down direction and the left-right direction and faces to the rear. In this state, the pressing surface 61 is disposed to the front of an opening of the peeling region 224 of the pressing portion 5. In a side view, a gap exists between the pressing surface 61 and the guide surfaces 51 in the front-rear direction.

The guide surfaces 51 are disposed at positions offset with respect to the pressing surface 61 in the left-right direction. In other words, the guide surface 51 and the pressing surface 61 do not face each other in the front-rear direction. Further, the size of the pressing surface 61 in the left-right direction is greater than the maximum width of the tape 150 corresponding to the label affixing device 1.

When the cable 19 passes in the guide direction Y4 along the guide path R4 between the guide surfaces 51 and the pressing surface 61, the pressing surface 61 presses the end portion of the label 160 against the cable 19 using an urging force. The pressing surface 61 extends to be longer than the guide surfaces 51 in the guide direction Y4. This is to ensure that the pressing of the end portion of the label 160 by the pressing surface 61 is maintained until the label 160 is peeled away from the release material 170.

When a position P2 is a furthermost downstream position in the guide direction Y4 of the pressing surface 61 in the guide path R4, a virtual line joining the position P2 and the connection portion 235 is a virtual line L. The pressing surface 61 extends to the position P2 at which an angle θ3 between the conveying direction Y2 and the virtual line L is in a range from 40 degrees to 90 degrees. By causing the angle θ3 to be equal to or greater than 40 degrees, the label affixing device 1 can increase an angle between the label 160 and a backing sheet when peeling the label 160, and to lower a load necessary for the peeling away. In particular, when the angle θ3 is 90 degrees, a load pulling in the conveying direction Y2 does not act on the release material 170.

In this way, the label affixing device 1 can reduce a force by which the label 160 pulls the release material 170 when peeling away the label 160. Thus, the label affixing device 1 can avoid a situation in which the tape 150 before the printing is erroneously pulled out from the tape cassette 100. As a result, the print portion 3 can suppress the occurrence of distortion in the tape 150 when printing. Further, the pressing surface 61 extends from the affixing position P1 to the position P2. Thus, the pressing surface 61 can maintain the state of pressing the end portion of the label 160 against the cable 19 until the label 160 is peeled away from the release material 170.

The pressing member 60 further includes a support surface 62 and an inclined surface 63. The support surface 62 is connected to the upper end of the pressing surface 61 and faces diagonally upward to the rear in the closed state of the opening/closing member 6. When the user disposes the cable 19 at the affixing position, the support surface 62 guides the position of the cable 19 in the front-rear direction.

Further, the end portion of the label 160 peeled away from the release material 170 is disposed in a state of being raised up over the support surface 62. Thus, when the user affixes the end portion of the label 160 to the cable 19, the end portion of the label 160 is clamped between the support surface 62 and the cable 19 and is adhered to the cable 19. Furthermore, since the support surface 62 is inclined to the front, at the time of contact with the cable 19, a force is imparted from the cable 19, and the support surface 62 can move the upper end portion of the pressing member 60 to the front. As a result, when the outer diameter of the cable 19 is larger than the gap between the pressing surface 61 and the guide surfaces 51, the support surface 62 can widen the gap between the pressing surface 61 and the guide surfaces 51.

The inclined surface 63 is connected to the lower end of the pressing surface 61 and faces diagonally downward to the rear in the closed state. When the cable 19 around which the label 160 has been wrapped by the wrapping portion 7 is moved upward and removed from the wrapping portion 7, the inclined surface 63 guides the cable 19 to the gap between the pressing surface 61 and the guide surfaces 51. Furthermore, since the inclined surface 63 is inclined to the front, at the time of contact with the cable 19, a force is imparted from the cable 19, and the inclined surface 63 can move the upper end portion of the pressing member 60 to the front. As a result, when the outer diameter of the cable 19 is larger than the gap between the pressing surface 61 and the guide surfaces 51, the inclined surface 63 can widen the gap between the pressing surface 61 and the guide surfaces 51.

### Pressing portion 5

The pressing portion 5 is a portion that presses the end portion of the label 160 against the cable 19 in the course of guiding, to the wrapping portion 7, the cable 19 to which the end portion of the label 160 has been affixed at the affixing position. The pressing portion 5 presses the end portion of the label 160 against the cable 19 so that the end portion of the label 160 does not peel away. The pressing portion 5 includes the pressing member 60 of the opening/closing member 6, the middle portion 22 of the base body 20, and a moving member 50.

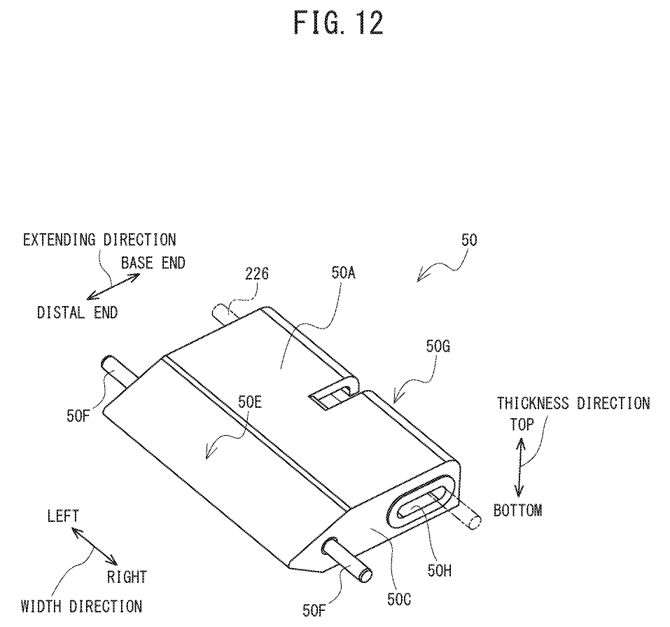

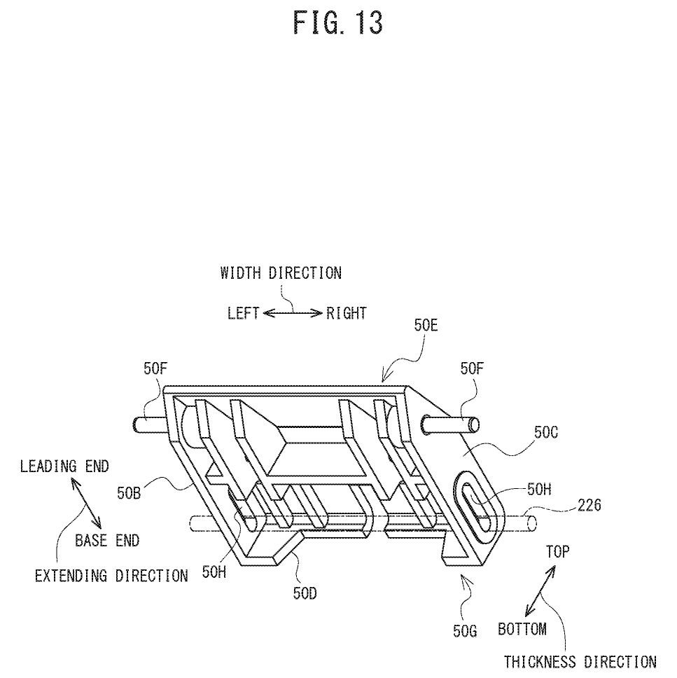

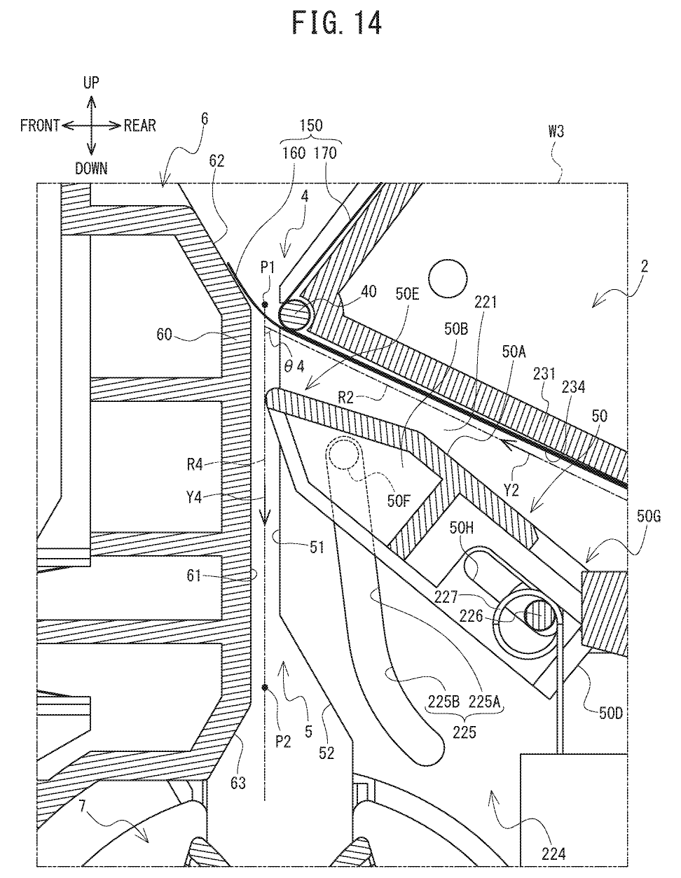

The moving member 50 is disposed in the peeling region 224 of the middle portion 22. The peeling region 224 is a region surrounded by the left wall 221, the right wall 222, the connecting wall 223, and the first wall 231. As shown in FIG. 12 to FIG. 14, the moving member 50 has a box shape extending in a width direction and an extending direction and having a thickness. The moving member 50 includes a top wall 50A, a left wall 50B, a right wall 50C, and a base portion wall 50D. The top surface of the top wall 50A is flat. The left wall 50B, the right wall 50C, and the base portion wall 50D respectively extend toward a bottom surface from edge portions at the left portion, the right portion and a base portion of the top wall 50A.

The bottom surface of the moving member 50 is open. In the top wall 50A, the surface on the opposite side to the top surface is reinforced by ribs. A center section in the width direction of the base portion wall 50D is cut out. A thickness of a distal portion 50E decreases the further toward the distal end.

At the distal end portion 50E, the left wall 50B and the right wall 50C include pins 50F that protrude in the width direction. The pins 50F engage with guide holes 225 respectively formed in the left wall 221 and the right wall 222 of the peeling region 224. Each of the guide holes 225 includes a first guide hole 225A and a second guide hole 225B. The first guide hole 225A extends in a straight line in the up-down direction in a side view. The second guide hole 225B is connected to the lower end of the first guide hole 225A and extends in an arc shape.

At a base portion 50G, the left wall 50B and the right wall 50C, include guide holes 50H. Each of the guide holes 50H is a long hole extending in the extending direction. A shaft body 226 that extends in the width direction is inserted through the guide holes 50H. The shaft body 226 is supported by the left wall 221 and the right wall 222 of the peeling region 224. A torsion spring 227 is assembled to the shaft body 226. The torsion spring 227 urges the moving member 50 such that the distal portion 50E is positioned higher than the base portion 50G.

The guide surfaces 51 are disposed at both the left and right of the peeling region 224. The guide surfaces 51 guide the cable 19 to which the label 160 has been affixed at the affixing position P1 to the wrapping portion 7. The user grips the cable 19 extending in the left-right direction with both hands and brings the cable 19 into contact with the guide surfaces 51. The user moves the cable 19 downward along the guide surfaces 51 toward the wrapping portion 7 positioned below the affixing position P1.

The cable 19 passes along the guide path R4 between the guide surfaces 51 and the pressing surface 61 in the guide direction Y4 and reaches the wrapping portion 7. The guide direction Y4 is the direction in which the cable 19 moves along the guide surfaces 51 extending in the up-down direction. In other words, the guide direction Y4 is the downward direction in the vertical direction.

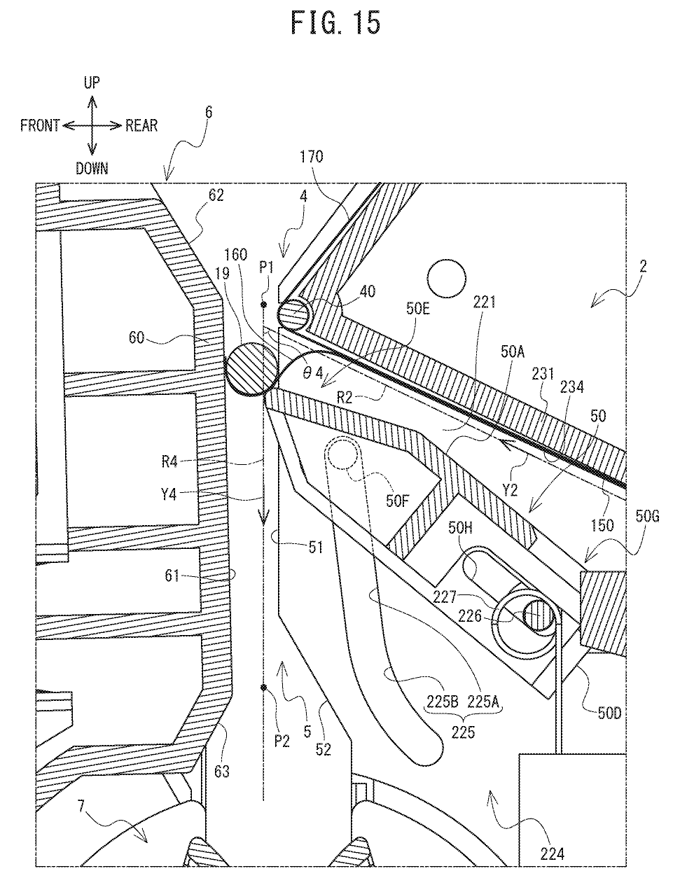

As shown in FIG. 15, when the cable 19 moves in the guide direction Y4, the conveyance of the tape 150 in the conveying path R2 is stopped. The tape 150 is held in a state of being pinched between the conveyance roller 34 and the drive roller 101. Even when a force is applied in a direction to pull the tape 150 from the print portion 3, the tape 150 is suppressed from being pulled out. The conveying path R2 is exposed at the peeling region 224. Thus, the label 160 whose end portion is affixed to the cable 19 is peeled away from the release material 170 inside the peeling region 224, in accordance with the movement of the cable 19 in the guide direction Y4.

An angle θ4 between the conveying direction Y2 of the tape 150 in the conveying path R2 and the vertical downward direction that is the direction in which the guide surfaces 51 extend is equal to or less than 90 degrees. The angle θ4 is set such that the label 160 is smoothly peeled away from the release material 170 by the movement of the cable 19 to which the end portion of the label 160 is affixed. When the angle θ4 is an obtuse angle greater than 90 degrees, the force necessary for peeling the label 160 from the release material 170 increases. When the pulling and peeling away of the label 160 is performed in this state, the tape 150 stopped on the conveying path R2 is pulled together with the label 160. As a result, it is difficult to cleanly peel away the label 160. Thus, the inclination angles of the first wall 231 and the third wall 234 are set such that the angle θ4 is equal to or less than 90 degrees.

The moving member 50 is urged by the torsion spring 227. In a state in which a load is not acting on the moving member 50, the distal portion 50E protrudes inside the guide path R4 below the affixing position P1 and is positioned further to the front than the guide surfaces 51 in a side view. When the cable 19 to which the end portion of the label 160 is affixed moves from the affixing position P1 along the guide path R4 in the guide direction Y4, the distal portion 50E of the moving member 50 comes into contact with the cable 19. The distal portion 50E clamps the end portion of the label 160 from downstream in the guide direction Y4 between the distal portion 50E and the cable 19. Due to the urging of the compression coil spring 6C, the pressing surface 61 of the pressing member 60 maintains the state of pressing the end portion of the label 160 against the cable 19.

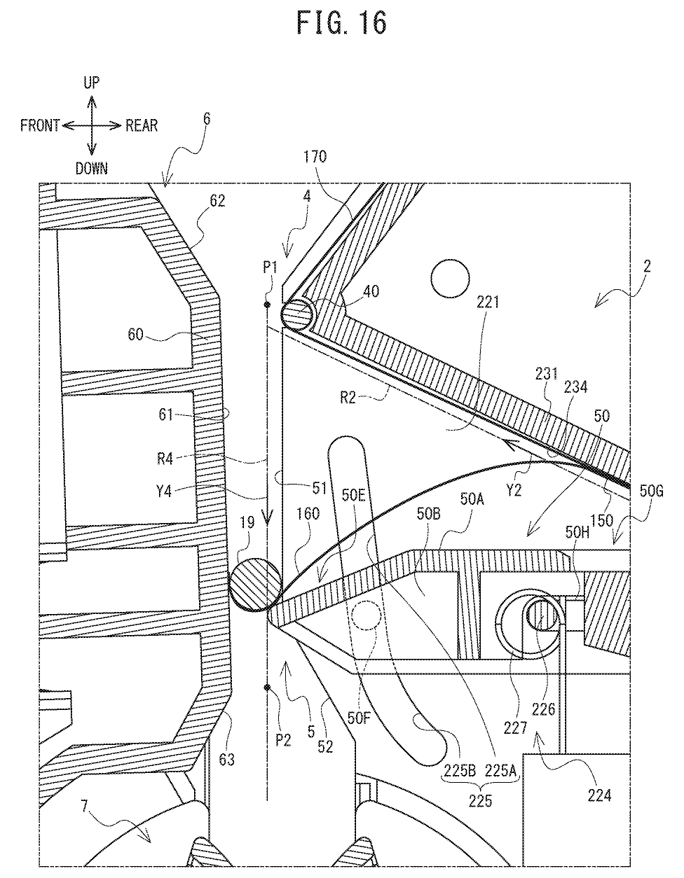

As shown in FIG. 16, when the cable 19 moves in the guide direction Y4, due to the pressing of the cable 19, of the moving member 50, the distal portion 50E rotates downward around the shaft body 226. As a result of the guide holes 50H moving with respect to the shaft body 226, the moving member 50 can displace a position of a fulcrum of the rotation. The pins 50F move along the straight line-shaped first guide holes 225A of the guide holes 225. Thus, the distal portion 50E of the moving member 50 maintains the state of protruding inside the guide path R4. The distal portion 50E maintains the state in which the end portion of the label 160 is clamped between the distal portion 50E, from downstream in the guide direction Y4, and the cable 19, and, together with the cable 19, pulls and peels the label 160 from the release material 170.

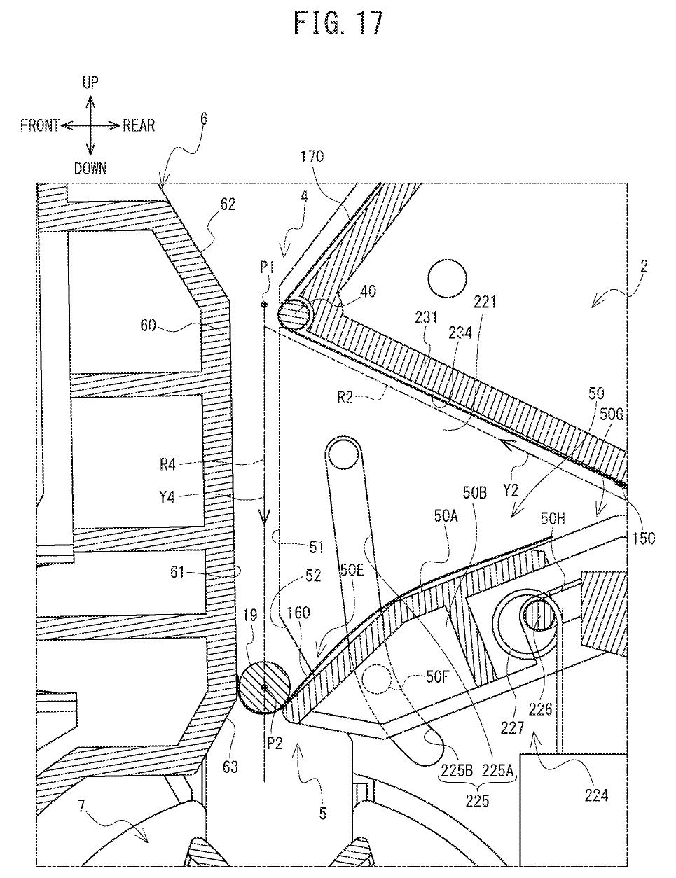

As shown in FIG. 17, the guide surfaces 51 are shorter than the pressing surface 61 in the up-down direction. When the distal portion 50E moves further downward than a furthermost downstream position of the guide surfaces 51 in the guide direction Y4, the pins 50F move along the arc-shaped second guide holes 225B of the guide holes 225. The second guide holes 225B are curved in a direction separating from the guide path R4 toward the rear. Thus, the distal portion 50E gradually retracts from the guide path R4 in accordance with the movement of the cable 19 in the guide direction Y4. When the cable 19 moves further in the guide direction Y4 and reaches the furthermost downstream position P2 of the pressing surface 61 in the guide path R4, the pressing of the end portion of the label 160 by the pressing surface 61 ends.

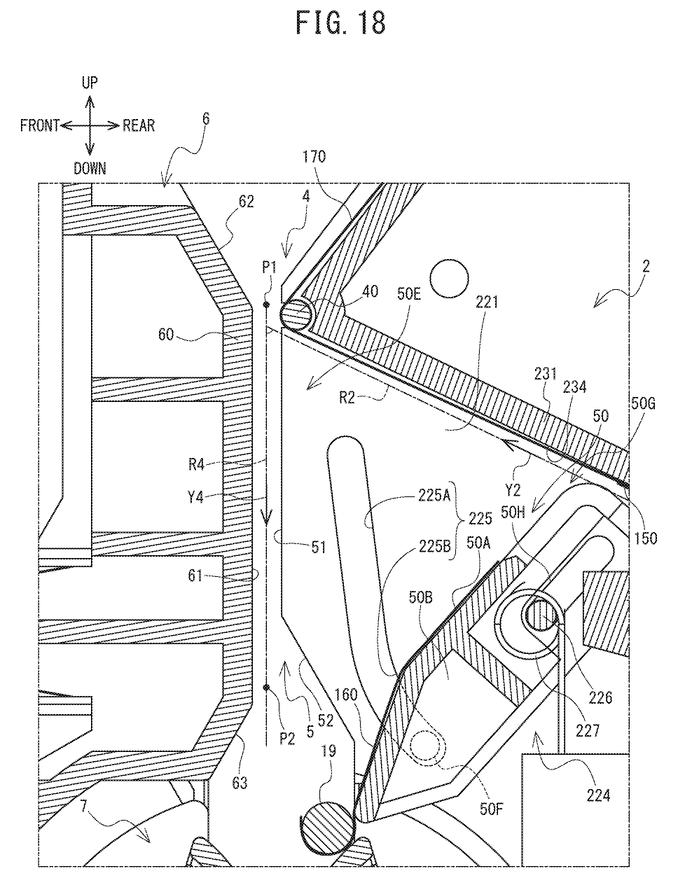

As shown in FIG. 18, the middle portion 22 of the base body 20 includes inclined surfaces 52 below the guide surfaces 51. The inclined surfaces 52 are connected to the lower ends of the guide surfaces 51 and face diagonally downward to the front. When the cable 19 around which the label 160 has been wrapped is moved upward and is removed from the wrapping portion 7, the inclined surfaces 52 guide the cable 19 into the gap between the pressing surface 61 and the guide surfaces 51.

When affixing the label 160, the user presses the cable 19 against the guide surfaces 51, and moves the cable 19 along the guide surfaces 51. Thus, the cable 19 sometimes moves along the inclined surfaces 52 from the lower ends of the guide surfaces 51. When the pins 50F move along the second guide holes 225B, the moving member 50 retracts further to the rear than the inclined surfaces 52. Thus, the moving member 50 does not obstruct the movement of the cable 19.

The label affixing device 1 cuts the tape 150 using the half-cut cutting blade 92 to a length corresponding to a thickness and application of the cable 19, and thus generates the label 160. The position P2, which is the position at which the pressing surface 61 ends the pressing of the end portion of the label 160, is a peeling completion position. The length of the label 160 is preferably a length at which the peeling of the label 160 from the release material 170 is complete when the cable 19 is at the peeling completion position.

Cases exist in which the label 160 is used having a length at which the peeling from the release material 170 cannot be completed even when the cable 19 has reached the position P2. When the cable 19 moves, the end portion of the label 160 is pressed against the cable 19 by the pressing surface 61, and is clamped by the moving member 50 between the moving member 50 and the cable 19. Thus, when the cable 19 has reached the position P2, the label 160 is in the state of being sufficiently strongly affixed to the cable 19. Thus, even with the long label 160, the label affixing device 1 can sufficiently perform the peeling away of the label 160 at a position further downstream in the guide direction Y4 than the position P2 simply using the adhesive force to the cable 19.

### Wrapping portion 7

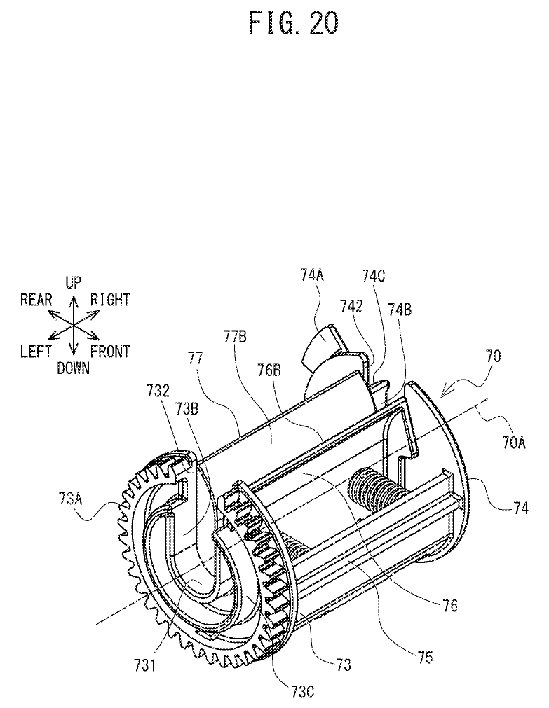

The wrapping portion 7 wraps the label 160, whose end portion is adhered to the cable 19 disposed at the wrapping position P3, around the cable 19 and thus affixes the label 160 to the cable 19. As shown in FIGS. 6, 7, and 19 to 21, the wrapping portion 7 includes the substantially cylindrical rotation body 70 having a side surface that is partially cut away. A rotational axis center 70A that is a center of rotation of the rotation body 70 extends in the left-right direction. The rotational axis center 70A is rotatably supported at the left support portion 71 fixed to the left surface of the left side plate 25 and the right support portion 72 fixed to the right surface of the right side plate 26, respectively.

The rotation body 70 includes a left side surface portion 73, a right side surface portion 74, and a peripheral surface portion 75. The left side surface portion 73 and the right side surface portion 74 are circular plates, and are separated facing each other in the left-right direction. The left side surface portion 73 includes an external gear 73A. The main unit 2 includes the drive mechanism 705 in the bottom portion 21. The external gear 73A is connected to the drive mechanism 705. The driving force generated by the motor 705A of the drive mechanism 705 is transmitted to the external gear 73A and input to the rotation body 70.

The left side surface portion 73 includes an insertion portion 73B. The insertion portion 73B is substantially U-shaped and is recessed from a peripheral end portion toward the rotational axis center 70A. The insertion portion 73B extends in a radial direction from a semicircular bottom portion 731 centered on the rotational axis center 70A to an opening 732 that corresponds to a part of the peripheral end portion of the left side surface portion 73.

The left side surface portion 73 includes the substantially C-shaped rotation shaft portion 73C. The rotation shaft portion 73C is disposed further inward than the external gear 73A in the radial direction of the rotational axis center 70A, and protrudes to the left along the peripheral direction excluding the insertion portion 73B. The rotation shaft bearing portion 71A is disposed at the right surface of the left support portion 71. The rotation shaft portion 73C engages with the rotation shaft bearing portion 71A and is rotatably supported.

A detection plate 74A is disposed at a peripheral edge portion of the right surface of the right side surface portion 74. The detection plate 74A is disposed at a position that is detected by a transmission type photosensor 701 (refer to FIG. 9) when the rotation body 70 is at a home position. The controller can stop the rotation body 70 at the home position, by performing control to stop the rotation of the rotation body 70 when the photosensor 701 detects the detection plate 74A. The home position is a position at which the cable 19 and the label 160 can be inserted into the insertion portion 73B and an insertion portion 74B, in a state in which the opening 732 and an opening 742 are disposed at the upper end portions of the bottom portion 731 and a bottom portion 741.

The photosensor 701 is disposed at a position diagonally above and to the rear of the housing portion 211 in the bottom portion 21 of the base body 20. The photosensor 701 is disposed at a position further to the rear than the position of the rotation body 70 disposed in the housing portion 211. In other words, the photosensor 701 is disposed at a position to the rear of the housing portion 211 when the opening/closing member 6 is open and the housing portion 211 is seen from the front.

As will be described later, the rotation body 70 can be removed from the housing portion 211, and can be installed in the housing portion 211. The rotation body 70 is installed in the housing portion 211 from the front toward the rear of the base body 20. In other words, an installation direction of the rotation body 70 to the housing portion 211 is the rearward direction. The photosensor 701 is disposed to the rear of the housing portion 211 in the installation direction of the rotation body 70.

The right side surface portion 74 includes the insertion portion 74B. The insertion portion 74B is substantially U-shaped and is recessed from a peripheral end portion toward the rotational axis center 70A. The insertion portion 74B extends in the radial direction from the semicircular bottom portion 741 centered on the rotational axis center 70A to the opening 742 that corresponds to a part of the peripheral end portion of the left side surface portion 73.

The right side surface portion 74 includes the substantially C-shaped rotation shaft portion 74C. The rotation shaft portion 74C is disposed further inward than the peripheral edge portion in the radial direction of the rotational axis center 70A, and protrudes to the right along the peripheral direction excluding the insertion portion 74B. The rotation shaft bearing portion 72A is disposed at the left surface of the right support portion 72. The rotation shaft portion 74C engages with the rotation shaft bearing portion 72A and is rotatably supported.

The peripheral surface portion 75 has a semicircular cylindrical shape extending in the left-right direction, and is disposed between the left side surface portion 73 and the right side surface portion 74. In a side view, the peripheral surface portion 75 is substantially U-shaped, and both ends of the peripheral surface portion 75 are connected to the left side surface portion 73 and the right side surface portion 74, respectively. An open section of the peripheral surface portion 75 and open sections of the insertion portions 73B and 74B are disposed to face in the same direction in the radial direction of the rotational axis center 70A. The peripheral surface portion 75 internally houses and swingably supports arm members 76 and 77.

When the rotation body 70 is in the state in which the openings 732 and 742 are disposed at the upper end portions of the bottom portions 731 and 741, the cable 19 and the label 160 can be inserted into the insertion portions 73B and 74B. The rotation position of the rotation body 70 in this state is the home position. In the following description, unless otherwise specified, the state in which the rotation body 70 is disposed at the home position. The insertion portions 73B and 74B are disposed below the affixing position P1 in the vertical direction, and further downstream than the position P2 of the guide path R4 in the guide direction Y4. The openings 732 and 742 of the insertion portions 73B and 74B are open toward the front surface Us of the end portion of the label 160 disposed at the affixing position P1.

The wrapping portion 7 includes the arm members 76 and 77, coil springs 78 and 79, and a support shaft 702 inside the rotation body 70. The arm members 76 and 77 clamp and hold the cable 19 when the label 160 is wrapped around the cable 19 by the wrapping portion 7. The arm member 76 and the arm member 77 are metal members having the same shape as each other.

The arm members 76 and 77 respectively include clamp portions 76A and 77A, receiving portions 76B and 77B, shaft bearing portions 76C and 77C, spacers 76D and 77D, and retainers 76E and 77E. The clamp portions 76A and 77A have a flat plate shape extending in the left-right direction and the up-down direction and are disposed facing each other with a gap between the clamp portions 76A and 77A in the front-rear direction. In each of the clamp portions 76A and 77A, the spacers 76D and 77D are respectively disposed at positions closer to the left and right ends than to the center, in the left-right direction, of the clamp portions 76A and 77A. The spacers 76D and 77D come into contact with each other to secure the gap between the clamp portions 76A and 77A.

The shaft bearing portions 76C and 77C are disposed close to the spacers 76D and 77D of the clamp portions 76A and 77A. The single support shaft 702 is inserted into the shaft bearing portions 76C and 77C. Thus, the arm members 76 and 77 swing around the shared support shaft 702.

The left end of the support shaft 702 is supported, at the left side surface portion 73 of the rotation body 70, at a position further outward in the radial direction of the rotational axis center 70A than the bottom portion 731 of the insertion portion 73B. The right end of the support shaft 702 is supported, at the right side surface portion 74 of the rotation body 70, at a position further outward in the radial direction of the rotational axis center 70A than the bottom portion 741 of the insertion portion 74B. Thus, the end portions of the arm members 76 and 77 on the opposite side to the support shaft 702 swing so as to approach each other and separate from each other.

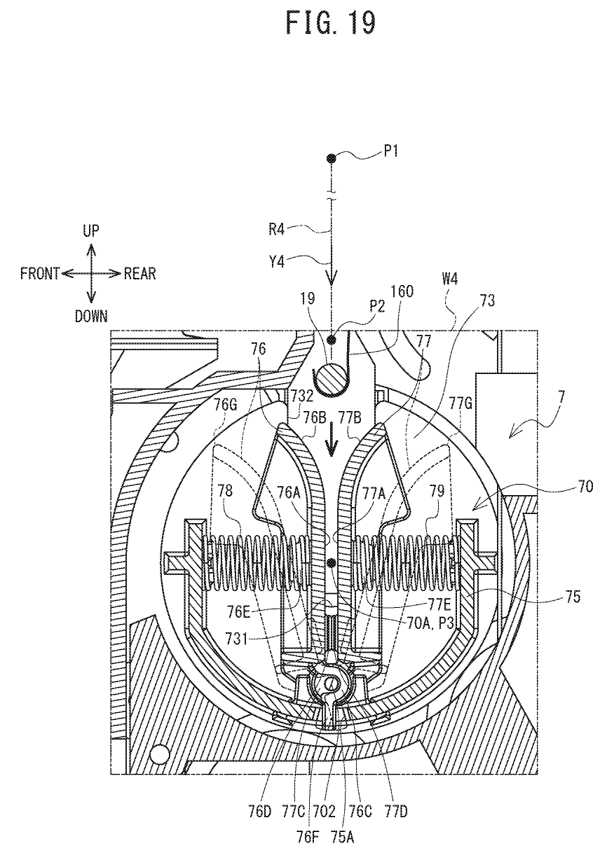

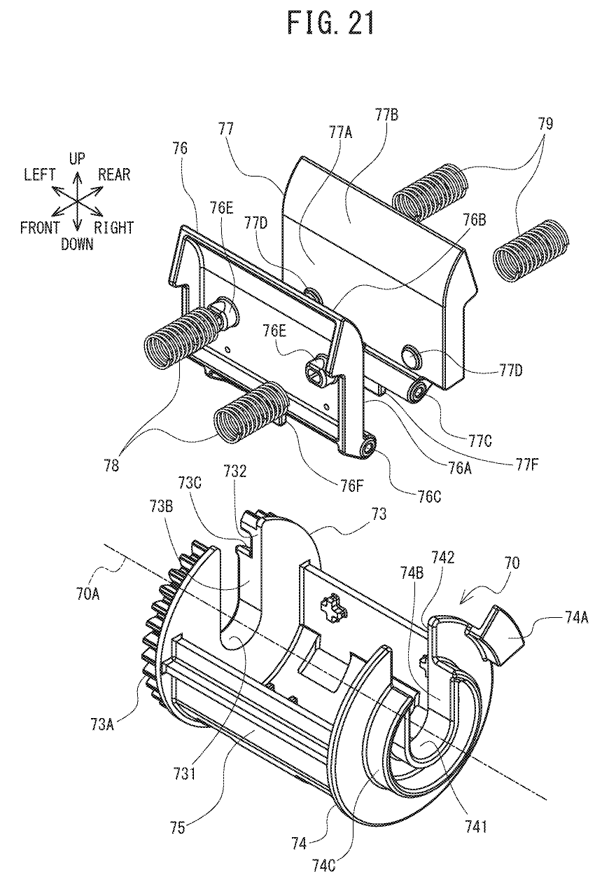

The shaft bearing portions 76C and 77C include protrusions 76F and 77F (refer to FIG. 21). The protrusions 76F and 77F extend in the opposite direction to the clamp portions 76A and 77A. The rotation body 70 includes an opening 75A (refer to FIG. 19) at a bottom section of the peripheral surface portion 75. The protrusions 76F and 77F are disposed inside the opening 75A.

When the arm members 76 and 77 swing around the support shaft 702 and a swinging range of the arm members 76 and 77 reaches a predetermined range, the protrusions 76F and 77F come into contact with edges of the opening 75A. In other words, the opening 75A defines the swinging range of the arm members 76 and 77 (refer to dotted lines in FIG. 19). The swinging range is a range over which distal ends 76G and 77G of the arm members 76 and 77 do not move beyond an external periphery of the left side surface portion 73 and the right side surface portion 74, namely, do not move beyond an external periphery of the rotation body 70.

The receiving portions 76B and 77B are disposed at the end portions of the arm members 76 and 77 in the opposite direction to the support shaft 702, and are respectively connected to the clamp portions 76A and 77A. The receiving portions 76B and 77B are curved so as to separate from each other in the front-rear direction. In other words, in a side view, the size of the gap between the receiving portions 76B and 77B becomes gradually narrower toward the inner direction in the radial direction of the rotational axis center 70A.

Surfaces of the clamp portion 76A and the receiving portion 76B facing a direction in which the rotational axis center 70A is disposed are smoothly connected surfaces. The connected surfaces of the clamp portion 76A and the receiving portion 76B have a coating layer that suppresses attachment of the adhesive to the surfaces. In a similar manner, surfaces of the clamp portion 77A and the receiving portion 77B facing the direction in which the rotational axis center 70A is disposed are smoothly connected surfaces. The connected surfaces of the clamp portion 77A and the receiving portion 77B have a coating layer that suppresses attachment of the adhesive to the surfaces. The receiving portions 76B and 77B guide the cable 19 moving from the pressing portion 5 to the wrapping portion 7 toward the rotational axis center 70A in the front-rear direction, and guide the cable 19 into the gap between the clamp portions 76A and 77A.

The retainers 76E and 77E are disposed at surfaces on opposite sides to the mutually facing surfaces of the clamp portions 76A and 77A, and hold first ends of the coil springs 78 and 79. Second ends of the coil springs 78 and 79 are held at the inner surface of the peripheral surface portion 75 of the rotation body 70. The arm members 76 and 77 are respectively urged in the direction of the rotational axis center 70A by the coil springs 78 and 79. The clamp portions 76A and 77A clamp and hold the cable 19 inserted into the gap between the clamp portions 76A and 77A.

The wrapping portion 7 further includes the lever members 706 and 707, and microswitches 708 and 709. The microswitches 708 and 709 detect the cable 19 at each of guide positions at the left support portion 71 and the right support portion 72, namely, when the cable 19 has reached the bottom portions 71C and 72C. When sections of the cable 19 corresponding to the guide portions 71B and 72B are positioned at the guide positions, the section of the cable 19 corresponding to the rotation body 70 is positioned at the wrapping position P3. The wrapping position P3 is a position of the rotational axis center 70A at the bottom portions 731 and 741 of the insertion portions 73B and 74B, or a position in the vicinity of the position of the rotational axis center 70A at the bottom portions 731 and 741 of the insertion portions 73B and 74B.

The bottom portions 731 and 741 are semicircular curved surfaces centered on the rotational axis center 70A that is the center of rotation of the rotation body 70. A radius of curvature of the bottom portions 731 and 741 has a size corresponding to the cable 19 having a maximum outer diameter, among outer diameters of the cables 19 around which the label affixing device 1 can wrap the label 160. Thus, when the cable 19 having the outer diameter that is not the maximum diameter comes into contact with the bottom portions 731 and 741, a position of a center line of the cable 19 is not aligned with the rotational axis center 70A.

The wrapping portion 7 can perform the wrapping of the label 160 even when the position of the center line of the cable 19 is displaced from the position of the rotational axis center 70A of the rotation body 70. Thus, when the cable 19 is positioned at the guide positions, the wrapping position P3 is a position at which the section of the cable 19 corresponding to the rotation body 70 is disposed. Thus, the wrapping position P3 is not necessarily aligned with the rotational axis center 70A.

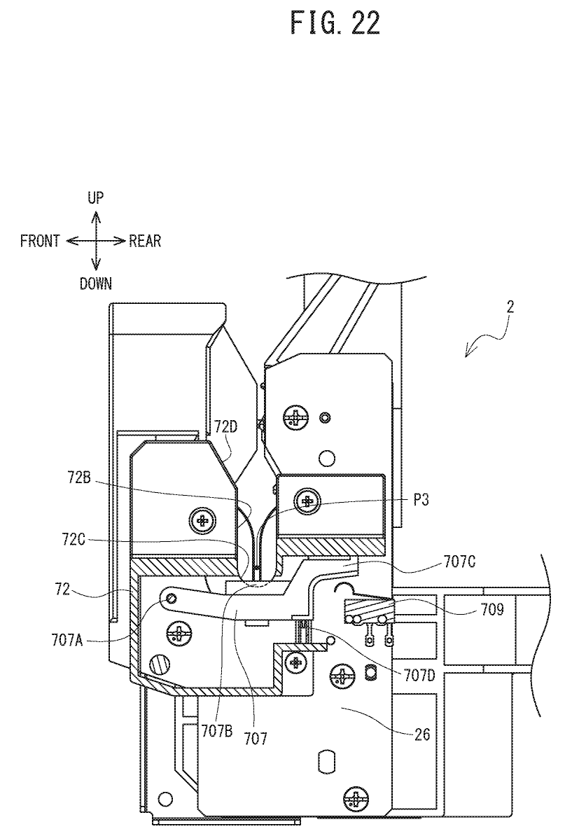

As shown in FIG. 22, the lever member 707 has a plate shape extending while curving in a stepped manner in the front-rear direction. The lever member 707 includes a support portion 707A, the input portion 707B, and an action portion 707C. The support portion 707A is a fulcrum rotatably supporting the lever member 707 and is disposed at the front end portion of the lever member 707. The lever member 707 is assembled to the left surface of the right support portion 72. A shaft body is disposed at the left surface of the right support portion 72. The shaft body protrudes to the left of the right support portion 72, and engages with the support portion 707A.

The rear end of the lever member 707 is urged upward by a coil spring 707D. The input portion 707B is disposed at the upper surface of a center portion of the lever member 707 and protrudes upward. The right support portion 72 includes the opening in the bottom portion 72C of the guide portion 72B. A part of the input portion 707B is exposed at the bottom portion 72C via the opening. The input portion 707B swings the lever member 707 as a result of being pressed by the cable 19 guided to the bottom portion 72C.

The action portion 707C is disposed at the rear end of the lever member 707. The action portion 707C is positioned to the rear of and higher than the input portion 707B and the support portion 707A, in the state in which the input portion 707B is exposed at the bottom portion 72C. The microswitch 709 is disposed below the action portion 707C and is fixed to the right surface of the right side plate 26. The microswitch 709 is a switch for driving the drive portion that rotates the rotation body 70.

The action portion 707C is positioned higher than the input portion 707B. Thus, even when foreign material, such as water, attaches to the input portion 707B via the opening of the bottom portion 72C, the foreign material is not likely to reach the action portion 707C. Thus, the lever member 707 can suppress attachment of foreign material to the microswitch 709.

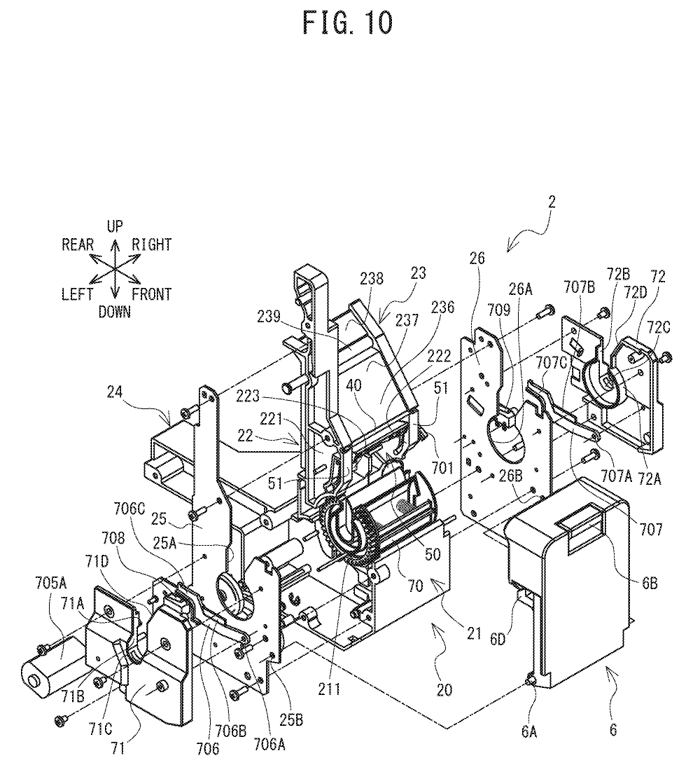

The lever member 706 shown in FIG. 10 is also configured in the same manner as the lever member 707. The lever member 706 has a plate shape extending while curving in a stepped manner in the front-rear direction. The lever member 706 includes a support portion 706A, the input portion 706B, and an action portion 706C. The support portion 706A is a fulcrum rotatably supporting the lever member 706 and is disposed at the front end portion of the lever member 706. The lever member 706 is assembled to the right surface of the left support portion 71. A shaft body is disposed at the right surface of the left support portion 71. The shaft body protrudes to the right of the left support portion 71, and engages with the support portion 706A.

The rear end of the lever member 706 is urged upward by a coil spring. The input portion 706B is disposed at the upper surface of a center portion of the lever member 706 and protrudes upward. The left support portion 71 includes the opening in the bottom portion 71C of the guide portion 71B. A part of the input portion 706B is exposed at the bottom portion 71C via the opening. The input portion 706B swings the lever member 706 as a result of being pressed by the cable 19 guided to the bottom portion 71C.

The action portion 706C is disposed at the rear end of the lever member 706. The action portion 706C is positioned to the rear of and higher than the input portion 706B and the support portion 706A, in the state in which the input portion 706B is exposed at the bottom portion 71C. The microswitch 708 is disposed below the action portion 706C and is fixed to the left surface of the left side plate 25. The microswitch 708 is a switch for driving the drive portion that rotates the rotation body 70.

The action portion 706C is positioned higher than the input portion 706B. Thus, even when foreign material, such as water, attaches to the input portion 706B via the opening of the bottom portion 71C, the foreign material is not likely to reach the action portion 706C. Thus, the lever member 706 can suppress attachment of foreign material to the microswitch 708.

The cable 19 that has moved in the guide direction Y4 along the guide path R4 and has separated the label 160 from the release material 170 moves further downward from the position P2. The guide surface 71D of the left support portion 71 and the guide surface 72D of the right support portion 72 come into contact with sections of the cable 19 located further outward in the left-right direction than a section to which the label 160 is affixed. The guide surfaces 71D and 72D guide the cable 19 to the guide portions 71B and 72B.

The cable 19 moves downward along the guide portions 71B and 72B. As shown in FIG. 19, the rotation body 70 is stopped at the home position. Thus, the cable 19 can enter into the insertion portions 73B and 74B. The cable 19 is guided by the guide portions 71B and 72B and the insertion portions 73B and 74B, and enters the gap between the clamp portions 76A and 77A of the arm members 76 and 77. The gap between the receiving portions 76B and 77B narrows in the downward direction. Thus, even when the movement direction of the cable 19 deviates in the front-rear direction, the cable 19 is guided to the receiving portions 76B and 77B, and enters the gap between the clamp portions 76A and 77A.

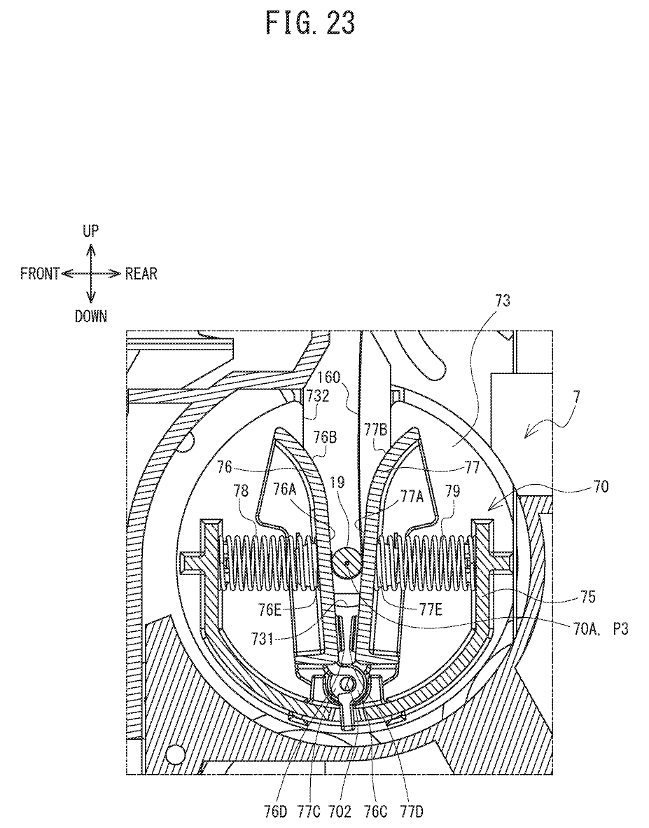

As shown in FIG. 23, when the cable 19 enters the gap between the clamp portions 76A and 77A, the cable 19 presses on the arm members 76 and 77. The arm members 76 and 77 swing around the shared support shaft 702. Thus, the cable 19 can push and widen the gap between the clamp portions 76A and 77A. Due to the urging force, the arm members 76 and 77 maintain the state of clamping and holding the cable 19 between the clamp portions 76A and 77A.

The cable 19 reaches the bottom portions 71C and 72C of the guide portions 71B and 72B, namely, reaches the guide positions. At this time, the section to which the end portion of the label 160 is affixed is disposed at the wrapping position P3 inside the rotation body 70. As shown in FIG. 23, the sections of the cable 19 that have reached the guide positions press the input portions 706B and 707B downward. As a result of the input portions 706B and 707B moving downward, the action portions 706C and 707C move downward.

The action portions 706C and 707C are at positions, respectively, that are farther from the support portions 706A and 707A than the input portions 706B and 707B. Thus, each of the action portions 706C and 707C moves downward by a distance longer than a distance by which each of the input portions 706B and 707B move downward as a result of being pressed by the cable 19. When the action portions 706C and 707C have moved downward, the action portions 706C and 707C come into contact with and turn on the microswitches 708 and 709, thus transmitting a detection result of the cable 19.

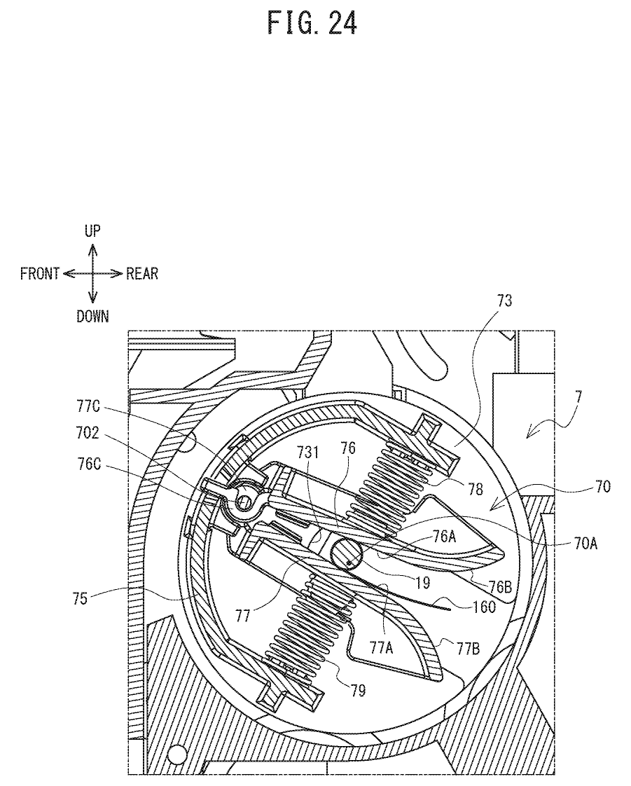

The controller drives the motor 705A when both the microswitch 708 and the microswitch 709 are turned on, and performs control to rotate the rotation body 70. As shown in FIG. 24, as a result of the rotation body 70 rotating, the label 160 is wrapped around the outer peripheral surface of the cable 19. Surfaces of the clamp portions 76A and 77A of the arm members 76 and 77 that come into contact with the cable 19 are flat surfaces. The arm members 76 and 77 are urged. Thus, even when the center position of the cable 19 is displaced with respect to the position of the rotational axis center 70A of the rotation body 70, the clamp portions 76A and 77A can constantly maintain the state of holding the outer peripheral surface of the cable 19.

Even when the outer diameter of the cable 19 is different, in a similar manner, the clamp portions 76A and 77A can constantly maintain the state of holding the outer peripheral surface of the cable 19. The rotation body 70 rotates in the state in which the cable 19 is held by the clamp portions 76A and 77A. In this way, the label 160 is wrapped around the outer peripheral surface of the cable 19, and is affixed to the cable 19 by the adhesive.

The controller controls a number of rotations and a rotation position of the rotation body 70 by the photosensor 701 detecting the detection plate 74A of the rotation body 70. When the number of rotations of the rotation body 70 reaches a number that is set in advance, the controller performs control to stop the rotation body 70 at the home position. In the home position, the openings 732 and 742 of the insertion portions 73B and 74B are positioned above the bottom portions 731 and 741. Thus, the cable 19 around which the label 160 has been wrapped can be removed from the insertion portions 73B and 74B and the guide portions 71B and 72B. When the cable 19 is discharged from the guide portion 72B, the lever member 707 moves the action portion 707C upward due to the urging force, and turns off the microswitch 709.

Subsequent to the wrapping of the label 160, the cable 19 moves in the opposite direction from the guide direction Y4. As shown in FIG. 11, the inclined surface 63 of the pressing member 60 and the inclined surface 52 of the middle portion 22 of the base body 20 guide the cable 19 to the position of the guide path R4. When the cable 19 passes along the guide path R4, the cable 19 presses the pressing surface 61 along the inclined surface 52. As a result, the upper end portion of the pressing member 60 moves to the front, thus pushing and widening the guide path R4 in the front-rear direction. The cable 19 passes through and out of the guide path R4, and the cable 19 to which the label 160 has been affixed is removed from the label affixing device 1.

Note that, by opening the opening/closing member 6, the user can remove the rotation body 70 from the housing portion 211 and can perform maintenance. As shown in FIG. 8, the user depresses the opening/closing button 6B of the opening/closing member 6 and opens the opening/closing member 6. The peeling region 224 of the pressing portion 5 and the housing portion 211 of the wrapping portion 7 are exposed at the front surface of the label affixing device 1.

The user removes the screws of the left support portion 71 and the right support portion 72 and removes the left support portion 71 and the right support portion 72 from the left side plate 25 and the right side plate 26, respectively. The engagement of the rotation shaft portions 73C and 74C of the rotation body 70 with the rotation shaft bearing portions 71A and 72A of the left support portion 71 and the right support portion 72 is released. Thus, the user can remove the rotation body 70 from the housing portion 211.

The photosensor 701 detects the detection plate 74A of the rotation body 70 in a non-contact manner. Furthermore, the photosensor 701 is disposed at the position to the rear of the housing portion 211. Thus, when removing the rotation body 70, it is not necessary to go to the trouble of removing a wiring line of the photosensor 701, releasing an engagement between the photosensor 701 and the detection plate 74A, for example.

Further, the microswitches 708 and 709 are respectively fixed to the left side plate 25 and the right side plate 26. Thus, when removing the left support portion 71 and the right support portion 72 from the left side plate 25 and the right side plate 26, it is not necessary for the user to remove wiring lines of the microswitches 708 and 709. The lever members 706 and 707 are respectively assembled to the left support portion 71 and the right support portion 72. At the left support portion 71 and the right support portion 72, the lever members 706 and 707 are held at positions separated from the microswitches 708 and 709 by the spring force of the coil spring 707D of the lever member 707. Thus, when the user removes the left support portion 71 and the right support portion 72 from the left side plate 25 and the right side plate 26, the lever members 706 and 707 do not interfere with the microswitches 708 and 709.

When installing the rotation body 70 in the housing portion 211, the user performs the operation as a reverse procedure to that when removing the rotation body 70. The user places the rotation body 70 in the housing portion 211. The user provisionally places the rotation shaft bearing portions 71A and 72A of the left support portion 71 and the right support portion 72 in the circular sections of the openings 25A and 26A of the left side plate 25 and the right side plate 26. The user provisionally fits and engages the rotation shaft portions 73C and 74C of the rotation body 70 with the rotation shaft bearing portions 71A and 72A of the left support portion 71 and the right support portion 72, respectively.

The user rotates the left support portion 71 and the right support portion 72 around the fulcrums of the rotation shaft bearing portions 71A and 72A, respectively. In this way, the positions between the guide portions 71B and 72B of the left support portion 71 and the right support portion 72, and the openings 25A and 26A of the left side plate 25 and the right side plate 26 are determined. The user tightens the screws, fixes the left support portion 71 and the right support portion 72 to the left side plate 25 and the right side plate 26, respectively, and ends the installation of the rotation body 70.

### Winding portion 8

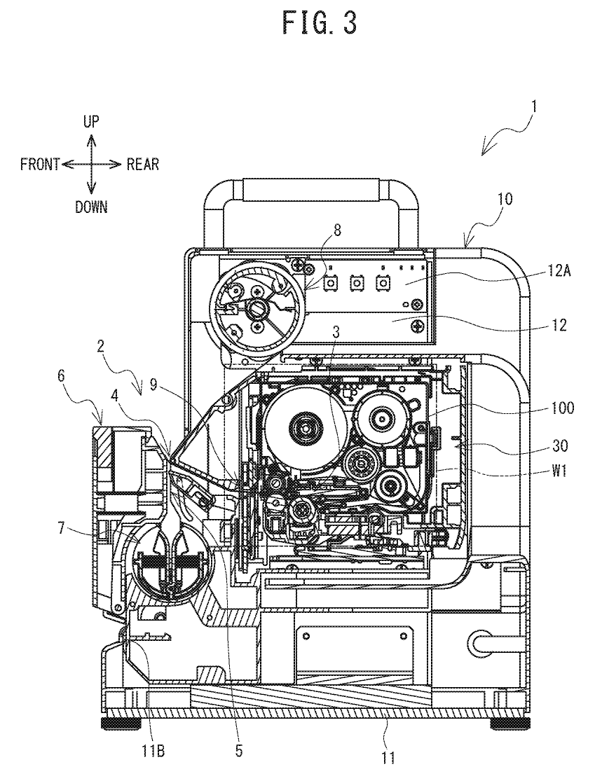

As shown in FIGS. 3 and 11, the winding portion 8 is positioned diagonally above and to the rear of the peeling member 4, and is disposed at the right surface of the main plate 12, above the upper front corner portion of the tape compartment 30. The winding portion 8 winds up, into a roll shape, the release material 170 from which the label 160 has been peeled at the peeling member 4. In this way, the winding portion 8 imparts a tension to the tape 150 necessary for the conveyance of the tape 150 and for the peeling away of the label 160.

As shown in FIG. 1, the winding portion 8 has a cylindrical shape. A rotational axis center 80A of the winding portion 8 extends in the left-right direction. The length of the winding portion 8 in the left-right direction is greater than the maximum width of the tape 150 corresponding to the label affixing device 1, namely, is greater than the maximum width of the label 160. The left end portion of the winding portion 8 is connected to the drive portion of the main plate 12, and the winding portion 8 rotates in the counterclockwise direction in a right side view, under the control of the controller.

The right end portion of the winding portion 8 is free. The release material 170 is wound onto the outer peripheral surface of the winding portion 8. When disposing of the release material 170, the release material roll 175 that is in the roll shape is removed to the right from the right end portion of the winding portion 8.

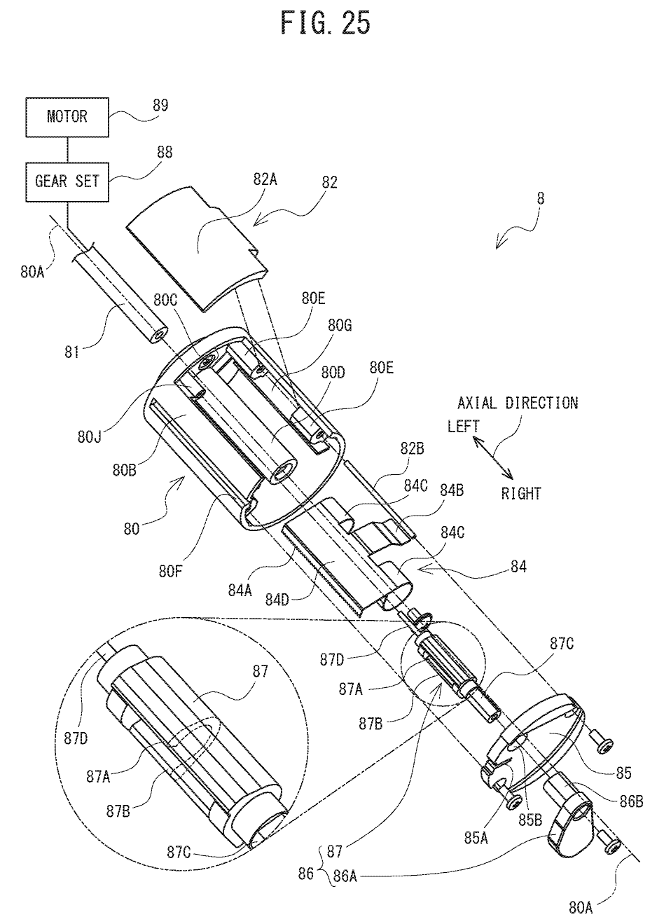

As shown in FIGS. 25 to 29, the winding portion 8 includes a reel 80, a rotation shaft 81, an advancing/retracting member 82, a presser member 84, a lid member 85, and an operation member 86. The reel 80 has a cylindrical shape and extends in an axial direction of the rotational axis center 80A. The left side surface of the reel 80 is closed, and an opening is formed at the center of the reel 80, through which the rotation shaft 81 extending from a gear set 88 of the drive portion is inserted. The opening for the rotation shaft 81 is connected to the inner peripheral surface of a tubular shaft 80D that extends to the right in a tubular shape from the left side surface, inside the reel 80. The rotation shaft 81 is screwed to the tubular shaft 80D by screws, at the right end of the tubular shaft 80D, and is fixed to the reel 80.

The gear set 88 of the drive portion transmits the driving force of a motor 89 disposed in the drive portion to the rotation shaft 81. The reel 80 rotates in accordance with the control of the motor 89 by the controller.

The right side surface of the reel 80 is open. The reel 80 has an opening 80C that extends through an outer peripheral surface 80B. The opening 80C opens the outer peripheral surface 80B over substantially one fourth of the breadth of the outer peripheral surface 80B. The opening 80C is open at the right side surface.

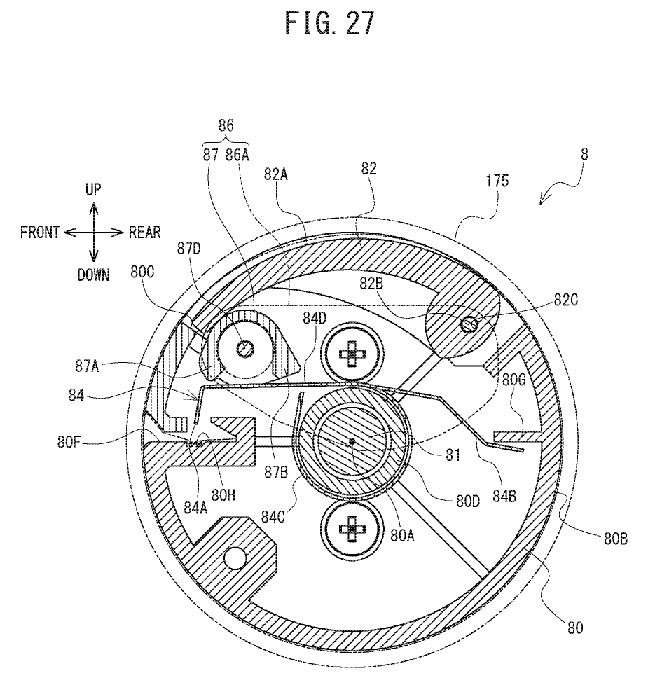

The advancing/retracting member 82 is disposed at the opening 80C. The advancing/retracting member 82 has a plate shape having substantially the same size as the breadth of the opening 80C. The advancing/retracting member 82 includes an outer surface 82A curved along the outer peripheral surface 80B. The advancing/retracting member 82 includes a shaft hole 82C (refer to FIG. 27) disposed at one end in the peripheral direction of the outer surface 82A, and through which a shaft 82B extending in the axial direction is inserted.

The shaft 82B is held by shaft bearings 80E inside the reel 80, at one end in the peripheral direction of the opening 80C of the reel 80. Thus, the advancing/retracting member 82 swings around the shaft 82B such that the other end in the peripheral direction of the outer surface 82A is a free end. The free end can enter and leave, in the radial direction, a gap between the inside and the outside of the reel 80, via the opening 80C.

The reel 80 includes an insertion slot 80F disposed in the outer peripheral surface 80B closer to the other end in the peripheral direction than the opening 80C. The insertion slot 80F has a slit shape extending in the axial direction. The inner wall of the insertion slot 80F extends inside the reel 80 to substantially the center in the radial direction. An end portion of the release material 170 to be wound by the winding portion 8 is inserted into the insertion slot 80F.

The presser member 84 is a metal plate spring. One end portion of the presser member 84 in a direction orthogonal to the axial direction is bent, and a presser portion 84A is formed at an edge section of the bent end portion. The presser portion 84A includes a plurality of teeth aligned in the axial direction.

The other end portion of the presser member 84 is divided into three sections in the axial direction. Support portions 84C are sections in both directions in the axial direction of the other end portion of the presser member 84. Each of the support portions 84C is curved in a cylindrical shape having a greater radius of curvature than the outer diameter of the tubular shaft 80D. The support portions 84C engage with the outer peripheral surface of the tubular shaft 80D, and support the presser member 84 to be rotatable around the tubular shaft 80D.

A restriction portion 84B is a central section of the other end portion in the axial direction of the presser member 84. The restriction portion 84B extends to the other end while bending in a stepped shape. In a state in which the presser portion 84A is disposed at the inner wall section of the insertion slot 80F, the restriction portion 84B is hooked onto a hook portion 80G disposed in the vicinity of the shaft bearings 80E inside the reel 80. The restriction portion 84B restricts the rotation of the presser member 84 in the counterclockwise direction in a right side view.

A flexible portion 84D is a section between the support portions 84C and the presser portion 84A. The flexible portion 84D is deformed by pressure from a first cam 87A. The flexible portion 84D is restored to an original state by an elastic force when the pressure is released.

A receiving toothed portion 80H (refer to FIG. 27) is disposed at the inner wall section of the insertion slot 80F. The receiving toothed portion 80H includes a plurality of receiving teeth. The plurality of receiving teeth extend in the axial direction, and have a stepped shape with respect to an insertion direction of the end portion of the release material 170. The insertion direction is orthogonal to the axial direction. The presser portion 84A of the presser member 84 is disposed at a position facing the teeth on the receiving toothed portion 80H.

The lid member 85 closes the right side surface of the reel 80. The lid member 85 is disposed at the inner portion of the right end portion of the reel 80 and is fixed by screws. The lid member 85 includes a removal opening 85A having a long thin cutout shape. The removal opening 85A is disposed at a position corresponding to an opening section on the right side surface of the insertion slot 80F, and is connected to the insertion slot 80F. From the state of being inserted into the insertion slot 80F, the end portion of the release material 170 can be pulled out from the removal opening 85A by sliding the end portion to the right.

The operation member 86 moves the free end of the advancing/retracting member 82 and the presser portion 84A of the presser member 84. The operation member 86 includes an operation portion 86A and a cam member 87. The operation portion 86A includes a rotation shaft 86B. The rotation shaft 86B is inserted into a support hole 85B of the lid member 85, and is rotatably supported.

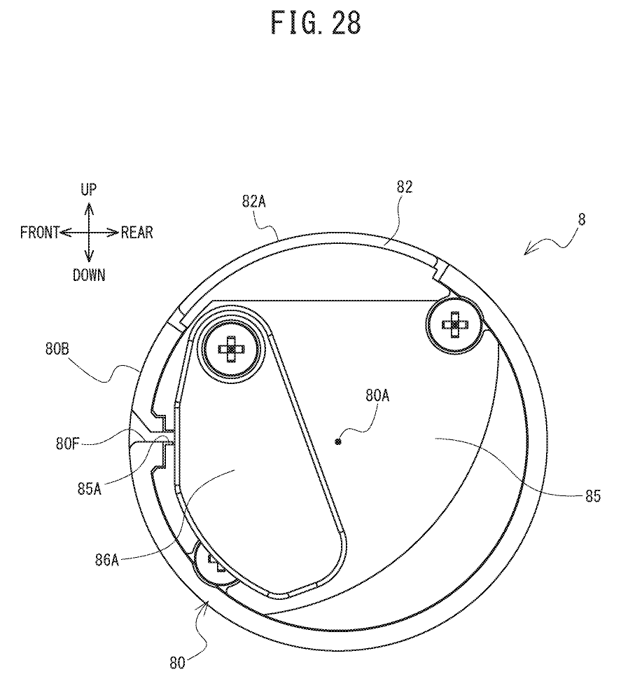

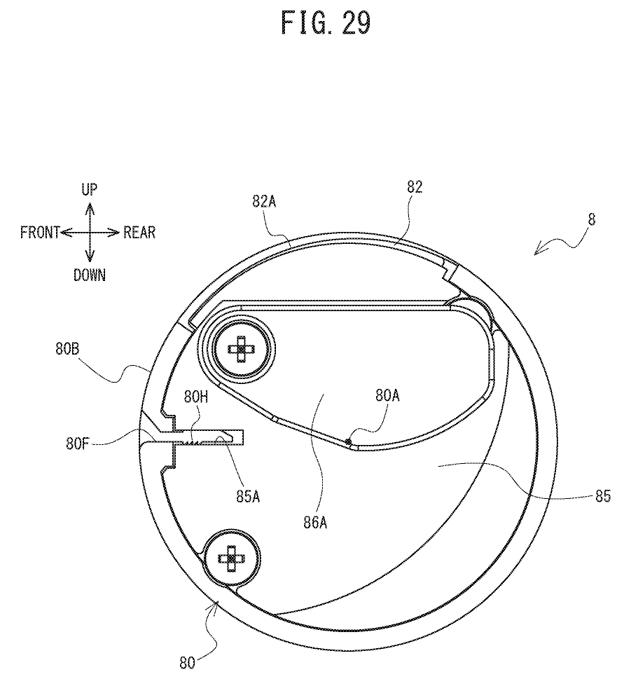

The operation portion 86A is disposed at the right side surface of the lid member 85. The operation portion 86A rotates between a first position (refer to FIG. 28) and a second position (refer to FIG. 29). The first position is a position at which the operation portion 86A overlaps with the removal opening 85A and the insertion slot 80F in the axial direction. The second position is a position at which the operation portion 86A does not overlap with the removal opening 85A and the insertion slot 80F in the axial direction.

The cam member 87 is disposed inside the reel 80. The cam member 87 includes a thick shaft 87C, a first cam 87A and a second cam 87B, and a thin shaft 87D. The thick shaft 87C extends in the axial direction, and is coupled to the rotation shaft 86B of the operation portion 86A. The first cam 87A and the second cam 87B are connected to the left end portion of the thick shaft 87C. The thin shaft 87D extends in the axial direction and is connected to the left end portions of the first cam 87A and the second cam 87B.

The thick shaft 87C and the thin shaft 87D are coaxial with each other. The reel 80 includes a shaft bearing portion 80J at the left side surface inside the reel 80. The thin shaft 87D is supported by the shaft bearing portion 80J. The cam member 87 is disposed between the free end of the advancing/retracting member 82 and the presser portion 84A of the presser member 84, inside the reel 80. The first cam 87A changes the position of the free end of the advancing/retracting member 82 in accordance with the rotation of the operation portion 86A.

When the operation portion 86A is at the first position, the first cam 87A presses the free end of the advancing/retracting member 82 to the outside in the radial direction. As a result, the advancing/retracting member 82 is disposed at an extended position. The extended position is a position at which the position of the outer surface 82A of the advancing/retracting member 82 in the radial direction is substantially the same as the position of the outer peripheral surface 80B of the reel 80 (refer to FIG. 26). When the operation portion 86A is at the second position, the first cam 87A releases the pressure applied to the free end of the advancing/retracting member 82. As a result, the advancing/retracting member 82 is disposed at a retracted position. The retracted position is a position at which the position of the outer surface 82A of the advancing/retracting member 82 in the radial direction is disposed further inward than the position of the outer peripheral surface 80B of the reel 80 (refer to FIG. 27).

The length of the reel 80 in the peripheral direction when the advancing/retracting member 82 is at the extended position will be referred to as a first peripheral length. The peripheral length is a shortest length of the reel 80 in the peripheral direction. In other words, the peripheral length is a shortest length of an outer contour line in a cross-section orthogonal to the rotational axis center 80A and including the opening 80C. The first peripheral length is a length of the outer contour line obtained by connecting a line along the outer peripheral surface 80B of the reel 80 and a line along the outer surface 82A of the advancing/retracting member 82 at the opening 80C. The first peripheral length is roughly the same as the length of the outer peripheral surface 80B of the reel 80 when the opening 80C is not present.

The length of the reel 80 in the peripheral direction when the advancing/retracting member 82 is at the retracted position will be referred to as a second peripheral length. The second peripheral length is a length of the outer contour line obtained by connecting the line along the outer peripheral surface 80B of the reel 80, a line along a part of the outer surface 82A of the advancing/retracting member 82 at the opening 80C, and a tangent line extending to the outer surface 82A from an edge portion of the opening 80C. The tangent line extending to the outer surface 82A from the edge portion of the opening 80C passes inside the opening 80C. Thus, the second peripheral length is shorter than the first peripheral length.

The second cam 87B changes the position of the presser portion 84A of the presser member 84 in accordance with the rotation of the operation portion 86A. When the operation portion 86A is at the first position, the second cam 87B is in a pressing state of pressing the flexible portion 84D. As a result of the flexible portion 84D deforming, the presser portion 84A moves to a contact position. The contact position is a position at which the presser portion 84A is in contact with the receiving toothed portion 80H formed at the inner wall of the insertion slot 80F (refer to FIG. 26).

When the operation portion 86A is at the second position, the second cam 87B is in a release state of releasing the pressure applied to the flexible portion 84D. The flexible portion 84D is restored to its original state by elastic force, and the presser portion 84A moves to a separated position. The separated position is a position at which the presser portion 84A is at a position separated from the receiving toothed portion 80H (refer to FIG. 27).

When winding the release material 170 from which the label 160 has been peeled, the user rotates the operation portion 86A and disposes the operation portion 86A at the second position. The pressing of the flexible portion 84D by the second cam 87B is released. The flexible portion 84D is restored by the elastic force, thus moving the presser portion 84A to the separated position.

The user inserts the end portion of the release material 170 into the insertion slot 80F of the reel 80. The end portion of the release material 170 is inserted deep into the insertion slot 80F without coming into contact with the presser portion 84A. The user rotates the operation portion 86A and disposes the operation portion 86A at the first position. The flexible portion 84D is pressed by the second cam 87B. Thus, the presser portion 84A moves to the contact position.

The presser portion 84A bites into and clamps the end portion of the release material 170 between the presser portion 84A and the receiving toothed portion 80H. Further, the flexible portion 84D urges the presser portion 84A using the elastic force. As a result of the urging force, the presser portion 84A applies a load to the end portion of the release material 170, and presses the end portion of the release material 170 against the receiving toothed portion 80H. Thus, when the winding by the winding portion 8 starts, the end portion of the release material 170 is not likely to be pulled out of the insertion slot 80F.

The user operates the operation panel 12A and issues a rotation command for the winding portion 8. The controller drives the motor 89 of the drive portion, rotates the rotation shaft 81, and rotates the reel 80 in the counterclockwise direction in a right side view. The release material 170 is wound by the winding portion 8. Thus, slack in the release material 170 is eliminated. Since the advancing/retracting member 82 is at the extended position, the length of the inner periphery of the release material roll 175 of the release material 170 wound by the winding portion 8 is the first peripheral length.

The outer peripheral surface 80B of the reel 80 is preferably a round cylindrical surface over which a distance in the radial direction with respect to the rotational axis center 80A is constant. Furthermore, the outer surface 82A of the advancing/retracting member 82 at the extended position preferably configures a round cylindrical surface having the same distance in the radial direction with respect to the rotational axis center 80A as that of the outer peripheral surface 80B of the reel 80. As a result of the outer peripheral surface 80B of the reel 80 and the outer surface 82A of the advancing/retracting member 82 configuring the round cylindrical surface, the winding portion 8 can suppress fluctuations in a speed of winding the release material 170 by the reel 80. Thus, in the print portion 3, unevenness in the printing on the label 160 is less likely to occur.

Inside the tape cassette 100, the release material 170 is wound around the tape spool 121, as the double-sided adhesive tape 120 adhered to the adhesive surface Ur of the base material 140. Thus, a coating treatment is carried out on both surfaces of the release material 170 to suppress the attachment of the adhesive, so that the double-sided adhesive tape 120 is fed out from the tape spool 121. Thus, at the time of conveyance, the release material 170 tends to slide easily. The winding portion 8 pulls the release material 170 by winding up the release material 170 using the driving force of the motor 89, and assists the conveyance. Thus, the winding portion 8 can impart a sufficient peeling force to the peeling member 4, in resistance to the sliding of the release material 170.

Note that a change between the outer diameter of the release material roll 175 when the winding portion 8 starts to wind the release material 170 and the outer diameter of the release material roll 175 when the winding up is complete is preferably suppressed to being within 20% or less of the outer diameter of the reel 80. At the half-cut position Ct of the label 160, in the release material 170, the surface of the label 160 is partially cut (refer to FIG. 6). Thus, when a pulling force caused by the winding by the winding portion 8 significantly changes, the release material 170 may break at the half-cut position Ct. Thus, the label affixing device 1 causes the change in the outer diameter of the release material roll 175 from the start to the end of the winding to be within 20% or less of the outer diameter of the reel 80. As a result, the label affixing device 1 can suppress changes in the pulling force on the release material 170, and can suppress breakage of the release material 170 during the winding.

The winding portion 8 winds up the release material 170 onto the outer peripheral surface 80B of the reel 80 while pulling the release material 170. Thus, the release material roll 175 is in a state of being firmly wound onto the reel 80, and cannot be easily removed from the reel 80. When removing the release material roll 175, the user rotates the operation portion 86A and disposes the operation portion 86A at the second position. The presser portion 84A moves to the separated position.

Further, the pressing by the first cam 87A is released, and the advancing/retracting member 82 can move to the retracted position. The advancing/retracting member 82 is pushed into the opening 80C by the release material roll 175 firmly wound onto the reel 80, and is disposed at the retracted position. The length in the peripheral direction of the reel 80 becomes the second peripheral length, and is shorter than the length of the inner periphery of the release material roll 175. Thus, a gap is generated between the inner surface of the release material roll 175 and the outer surface 82A of the advancing/retracting member 82, and the release material roll 175 moves easily over the outer peripheral surface 80B.

As shown in FIG. 28, when the operation portion 86A is at the first position, the operation portion 86A overlaps with the removal opening 85A in the axial direction. In this case, the user cannot see inside the insertion slot 80F. As shown in FIG. 29, when the operation portion 86A is at the second position, the operation portion 86A does not overlap with the removal opening 85A in the axial direction. In this case, the user can see inside the insertion slot 80F. Thus, simply by looking at the right side surface of the winding portion 8 and checking that the removal opening 85A does not overlap with the operation portion 86A, the user can ascertain whether a state is obtained in which the release material roll 175 can be removed.

The user moves the release material roll 175 in the axial direction, and removes the release material roll 175 from the right end portion of the reel 80. The operation portion 86A has moved to the position not overlapping with the removal opening 85A. Thus, the user can remove the end portion of the release material 170 to the outside of the insertion slot 80F in the axial direction, via the removal opening 85A.

As described above, the winding portion 8 can wind the release material 170 by winding, onto the reel 80, the release material 170 from which the label 160 has been peeled. At the time of winding, the winding portion 8 performs the winding in a state in which the advancing/retracting member 82 is disposed at the extended position. After the winding is complete, by disposing the advancing/retracting member 82 at the retracted position, the winding portion 8 can have the gap between the release material roll 175 and the outer peripheral surface 80B of the reel 80. As a result, the user can easily remove the release material roll 175 from the reel 80, without unwinding the release material roll 175.

By winding the release material 170 in the state in which the end portion of the release material 170 is inserted into the insertion slot 80F of the reel 80, the winding portion 8 can suppress the end portion from becoming detached at the start of the winding. In the reel 80, the rotation shaft 81 is not supported by the housing to the right of the rotational axis center 70A in the axial direction. When the winding of the release material 170 is complete, the user can remove the release material roll 175 in the other direction without unwinding. In this case, the user can smoothly perform the removal of the release material roll 175 by removing the end portion of the reel 80 from the removal opening 85A.

By operating the operation member 86 that includes the operation portion 86A at the side surface of the reel 80, the user can easily position the advancing/retracting member 82 at the extended position and the retracted position.

When the advancing/retracting member 82 is at the extended position, the operation portion 86A of the operation member 86 is disposed at the first position overlapping with the removal opening 85A in the side surface of the reel 80. In this case, since the removal opening 85A is covered by the operation portion 86A, the user can recognize the state in which the release material roll 175 cannot be removed. When the advancing/retracting member 82 is at the retracted position, the operation portion 86A of the operation member 86 is at the second position not overlapping with the removal opening 85A in the side surface of the reel 80. In this case, since the operation portion 86A is not covering the removal opening 85A, the user can recognize the state in which the release material roll 175 can be removed.

When winding the release material 170, the winding portion 8 holds the end portion of the release material 170 inserted into the insertion slot 80F using the presser portion 84A of the presser member 84. The presser portion 84A not only bites into the end portion of the release material 170 using the plurality of teeth, but also applies a load to the end portion using the urging of the flexible portion 84D, and can thus press the end portion against the inner surface of the insertion slot 80F. Thus, the winding portion 8 can suppress the release material 170 from becoming detached from the reel 80 at the start of the winding.

When the presser portion 84A comes into contact with the inner surface of the insertion slot 80F and bites into the end portion of the release material 170, the receiving toothed portion 80H bends the end portion of the release material 170 in a stepped shape. In this way, the receiving toothed portion 80H can increase a holding force of the end portion of the release material 170. Thus, the winding portion 8 can suppress the release material 170 from becoming detached from the reel 80 at the start of the winding.

The second cam 87B is the cam member 87. Thus, the load with which the second cam 87B presses the flexible portion 84D changes in accordance with the rotation position. Furthermore, as a result of the load being applied due to the urging of the flexible portion 84D, the presser portion 84A can increase the holding force of the end portion of the release material 170. Thus, the winding portion 8 can suppress the release material 170 from becoming detached from the reel 80 at the start of the winding.

The arm members 76 and 77 are urged, respectively, by the coil springs 78 and 79 in a direction such that the clamp portion 76A and the clamp portion 77A move closer to each other. Thus, the arm members 76 and 77 can clamp and press the cable 19 using the clamp portions 76A and 77A, regardless of the outer diameter of the cable 19 inserted into the wrapping position P3. The arm members 76 and 77 clamp the cable 19 inserted into the wrapping position P3, using the clamp portions 76A and 77A, and rotate around the wrapping position P3 together with the rotation body 70 in that state. Thus, the arm members 76 and 77 can maintain a state of contact of the clamp portions 76A and 77A even when the outer diameter of the cable 19 differs. As a result, the label affixing device 1 can wrap the label 160 on the cable 19.

The arm members 76 and 77 are axially supported at the rotation body 70 by the single support shaft 702 at each of the shaft bearing portions 76C and 77C. In other words, the arm members 76 and 77 swing around the support shaft 702, and can cause each of the clamp portions 76A and 77A to move closer to each other with the wrapping position P3 interposed between the clamp portions 76A and 77A. Thus, the arm members 76 and 77 can clamp the cable 19 having the differing diameters using the clamp portions 76A and 77A, maintain the contact state, and can wrap and affix the label 160.

The wrapping portion 7 holds the arm members 76 and 77 having the same shape on the rotation body 70. Thus, the label affixing device 1 can suppress manufacturing costs, and can prevent attachment of the wrong product at a time of assembly.

For example, when the cable 19 having the large diameter is inserted into the wrapping portion 7, the arm members 76 and 77 may be in a state of swinging to a significant extent. Even in this type of case, since the distal ends 76G and 77G are positioned inside the rotation body 70, they do not obstruct the rotation of the rotation body 70. Thus, the label affixing device 1 can perform the wrapping and affixing of the label 160 even to the cable 19 having the comparatively large diameter.

When the microswitch 708 and the microswitch 709 detect the cable 19, the cable 19 is disposed at the wrapping position P3 in the state of being parallel to the rotational axis center 70A of the rotation body 70. Since the rotation body 70 rotates in this state, the label affixing device 1 can stably perform the wrapping and affixing of the label 160 to the cable 19.

When the microswitch 708 and the microswitch 709 detect the cable 19, the cable 19 is disposed in the state of being parallel to the rotational axis center 70A of the rotation body 70 at the lowest position of the wrapping position P3. As a result of the rotation body 70 rotating in this state, the label affixing device 1 can stably perform the wrapping and affixing of the label 160 to the cable 19.

The adhesive is applied to the label 160. The coating layer of the arm members 76 and 77 suppresses the attachment of the adhesive to the arm members 76 and 77. Thus, the label affixing device 1 can stably perform the wrapping and affixing of the label 160 to the cable 19 over a long period of time.

Since the clamp portions 76A and 77A are made of metal, they have high durability, and the coating layer can easily be formed thereon. Thus, the label affixing device 1 can stably perform the wrapping and affixing of the label 160 to the cable 19 over a long period of time.

By releasing the fixing of the left side surface portion 73 to the left side plate 25, and releasing the fixing of the right side surface portion 74 to the right side plate 26, the rotation body 70 can be easily removed from the base body 20. Thus, in the label affixing device 1, repair, replacement, and maintenance of the wrapping portion 7 can be easily performed.

In the axial direction of the rotational axis center 70A, the bottom portion 731 of the insertion portion 73B and the bottom portion 741 of the insertion portion 74B are at the same position as the wrapping position P3. Thus, the wrapping position P3 is aligned with the bottom portion 731 and the bottom portion 741 and the rotation body 70 is easily positioned with respect to the left side surface portion 73 and the right side surface portion 74, and can thus be easily attached to the base body 20. Thus, in the label affixing device 1, the repair, replacement, and maintenance of the wrapping portion 7 can be easily performed.

Each of the rotation shaft portions 73C and 74C protrudes from the rotation body 70. Thus, the position of the rotation body 70 with respect to the left side surface portion 73 and the right side surface portion 74 is easily determined, and the rotation body 70 can be easily attached to the base body 20. Thus, in the label affixing device 1, the repair, replacement, and maintenance of the wrapping portion 7 can be easily performed.

The photosensor 701 is disposed at the base body 20. Thus, when attaching and removing the left side surface portion 73, the right side surface portion 74, and the rotation body 70 to and from the base body 20, the user does not need to attach and remove wiring of the photosensor 701. Thus, in the label affixing device 1, the repair, replacement, and maintenance of the wrapping portion 7 can be easily performed.

The photosensor 701 is disposed further to the rear than the housing portion 211 of the rotation body 70 in the base body 20. Thus, the left side surface portion 73, the right side surface portion 74, and the rotation body 70 do not interfere with the photosensor 701 when being attached to and removed from the base body 20. Thus, in the label affixing device 1, the repair, replacement, and maintenance of the wrapping portion 7 can be easily performed.

The action portions 706C and 707C of the lever members 706 and 707 are disposed at positions further from the support portions 706A and 707A than the input portions 706B and 707B. Thus, compared to a distance over which the input portions 706B and 707B move as a result of input to the input portions 706B and 707B, the distance over which the action portions 706C and 707C move is increased. As a result, compared to a case in which the microswitches 708 and 709 come into contact with the input portions 706B and 707B and perform direct detection, by coming into contact with the action portions 706C and 707C and performing indirect detection, the cable 19 can be accurately detected. Thus, the label affixing device 1 can stably detect the insertion of the cable 19 to the wrapping position P3.

The microswitches 708 and 709 are respectively fixed to the left side plate 25 and the right side plate 26. Thus, when attaching and removing the left side surface portion 73, the right side surface portion 74, and the rotation body 70 to and from the left side plate 25 and the right side plate 26, the user does not need to attach and remove wiring of the microswitches 708 and 709. Thus, in the label affixing device 1, the repair, replacement, and maintenance of the wrapping portion 7 can be easily performed.

At the time of fixing, attaching, and removing the left side surface portion 73 and the right side surface portion 74, the orientations of the left side surface portion 73 and the right side surface portion 74 are different from each other. Thus, at a time of repairing or replacing the wrapping portion 7, the left side surface portion 73 and the right side surface portion 74 can be provisionally installed in a state obtained before fixing the left side plate 25 and the right side plate 26, and thus do not fall off from the base body 20. Thus, in the label affixing device 1, the repair, replacement, and maintenance of the wrapping portion 7 can be easily performed.

Each of the action portions 706C and 707C of the lever members 706 and 707 is disposed at the position higher than the input portions 706B and 707B. Even if, for example, foreign material enters into the base body 20 from outside via the arrangement position of the input portions 706B and 707B, the foreign material does not easily reach the action portions 706C and 707C through the lever members 706 and 707. Thus, the foreign material does not easily reach the microswitches 708 and 709. Thus, the label affixing device 1 can suppress erroneous detection by the microswitches 708 and 709 and cause them to operate smoothly.

### Other

In the above-described embodiment, the cable 19 is an example of an adherend of the present disclosure. The motor 89 is an example of a first drive power source of the present disclosure. The opening 80C is an example of an opening of the present disclosure. The release material roll 175 is an example of a roll of the present disclosure. The first cam 87A is an example of a first arrangement portion of the present disclosure. The second cam 87B is an example of a second arrangement portion of the present disclosure.

The motor 705 is an example of a second drive power source of the present disclosure. The base body 20 is an example of a housing of the present disclosure. The wrapping position P3 is an example of an insertion position of the present disclosure. The downward direction is an example of an insertion direction of the present disclosure. The clamp portions 76A and 77A are, respectively, an example of a first pressing surface and a second pressing surface of the present disclosure. The arm members 76 and 77 are, respectively, an example of a first pressing member and a second pressing member of the present disclosure. The coil springs 78 and 79 are, respectively, an example of a first urging member and a second urging member of the present disclosure. The shaft receiving portions 76C and 77C are an example of base portions of the present disclosure. The support shaft 702 is an example of a shaft body of the present disclosure.

The distal ends 76G and 77G are an example of distal portions of the present disclosure. The microswitches 708 and 709 are, respectively, an example of a first detector and a second detector of the present disclosure. The insertion portions 73B and 74B are, respectively, an example of a first guide groove and a second guide groove of the present disclosure. The left side surface portion 73 and the right side surface portion 74 are, respectively, an example of a first support member and a second support member of the present disclosure. The left side plate 25 and the right side plate 26 are, respectively, an example of a first fixing portion and a second fixing portion of the present disclosure. The bottom portions 731 and 741 are, respectively, an example of a first guide position and a second guide position of the present disclosure. The rotation shaft portions 73C and 74C are, respectively, an example of a first supported portion and a second supported portion of the present disclosure.

The home position is an example of a rotation position of the present disclosure. The photosensor 701 is an example of a position detector of the present disclosure. The housing portion 211 is an example of an attachment position of the present disclosure. The input portions 706B and 707B are, respectively, an example of a first contact portion and a second contact portion of the present disclosure. The lever members 706 and 707 are, respectively, an example of a first transmission member and a second transmission member of the present disclosure. The support portions 706A and 707A are, respectively, an example of a first base end portion and a second base end portion of the present disclosure. The action portions 706C and 707C are, respectively, an example of a first distal end portion and a second distal end portion of the present disclosure.

### Modified examples

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

The printing method by the print portion 3 is not limited to that of the above-described embodiment. For example, the label affixing device 1 may use a receptor-type tape cassette to perform the printing. In this case, the tape cassette houses a tape in which a base material and a release material are laminated, the release material being adhered to the adhesive surface Ur of the base material to which the adhesive is applied, and an ink ribbon. The print portion 3 performs the printing on the surface of the tape on the opposite side to the adhesive surface. Note that, as the base material, the tape may use a die-cut label that is cut to a predetermined size in advance, for example.

The label affixing device 1 need not necessarily include the print portion 3 and the cutting portion 9. The printing on the tape 150 may be executed using an external print device. The label affixing device 1 may use the tape 150 that has been printed by the print device, and may affix a label to the cable 19. An object to which the label 160 is affixed is not limited to the cable 19, and may be another adherend. Further, the adhesive surface Ur of the tape 150 is not limited to being the surface to which the adhesive is applied, and may be caused to have adhesive properties by processing.

In the extended position, the outer surface 82A of the advancing/retracting member 82 is disposed at substantially the same position in the radial direction as the outer peripheral surface 80B of the reel 80. The configuration is not limited to this example, and the outer surface 82A may be disposed further outward in the radial direction than the outer peripheral surface 80B. In this case, the outer surface 82A of the advancing/retracting member 82 may be disposed at substantially the same position in the radial direction as the outer peripheral surface 80B of the reel 80 in the retracted position.

The outer surface 82A of the advancing/retracting member 82 need not necessarily have the curved shape along the outer peripheral surface 80B. For example, the advancing/retracting member may be a protruding portion having a narrow width extending along the axial direction, or may be a plurality of protruding portions separated in the axial direction. In other words, it is sufficient that the advancing/retracting member is configured to be able to cause the peripheral length in the retracted position to be shorter than the peripheral length in the extended position.

The presser portion 84A of the presser member 84 and the receiving toothed portion 80H of the insertion slot 80F bite into and hold the end portion of the release material 170 using the teeth. The configuration is not limited to this example, and the presser portion 84A and the receiving toothed portion 80H need not necessarily include the teeth. For example, a mode may be adopted in which the presser portion 84A and the receiving toothed portion 80H clamp and hold the end portion of the release material 170 between flat surfaces. The removal opening 85A need not necessarily be provided. In this case, it is sufficient that the user take out the end portion from the insertion slot 80F when removing the release material roll 175.

The operation member 86 rotates the operation portion 86A and moves the advancing/retracting member 82 and the presser member 84 to the extended position and the contact position, by the action of the cam member 87. The configuration to activate the cam member 87 is not limited to the rotational movement of the operation portion 86A. For example, the lid member 85 may include a long hole, and the operation portion 86A may slide and move along the long hole. Then, a format may be adopted in which the cam member 87 thus acts on each of the advancing/retracting member 82 and the presser member 84.

The arm members 76 and 77 of the rotation body 70 are made of metal, but as long as at least the clamp portions 76A and 77A are made of metal, other sections need not necessarily be made of metal. For example, a configuration may be adopted in which metal plates as the clamp portions 76A and 77A are attached to the arm members 76 and 77 made of resin. The arm members 76 and 77 are members having the same shape. The configuration is not limited to this example, and as long as the clamp portions 76A and 77A each have the flat surface shape, the arm members 76 and 77 may be members having a different shape from each other. The arm members 76 and 77 are supported by the single support shaft 702, but may be supported by the different support shafts 702. Further, a configuration may be adopted in which one of the arm members 76 and 77 is fixed and does not swing, and the other swings to adjust the gap between the clamp portions 76A and 77A in accordance with the outer diameter of the cable 19.

One of the microswitch 708 of the left side plate 25 or the microswitch 709 of the right side plate may be omitted. The left support portion 71 and the right support portion 72 respectively include the lever members 706 and 707. The configuration is not limited to this example, and the left side plate 25 and the right side plate 26 may respectively include the microswitches 708 and 709 along with the lever members 706 and 707. The action portions 706C and 707C of the lever members 706 and 707 are disposed higher than the input portions 706B and 707B. Not only the action portions 706C and 707C but also the microswitches 708 and 709 may be disposed higher than the input portions 706B and 707B in the vertical direction. As long as the microswitches 708 and 709 are higher than the input portions 706B and 707B, even if foreign material enters through the openings of the bottom portions 71C and 72C, for example, the foreign material does not easily reach the microswitches 708 and 709. Thus, the microswitches 708 and 709 can suppress erroneous detection.

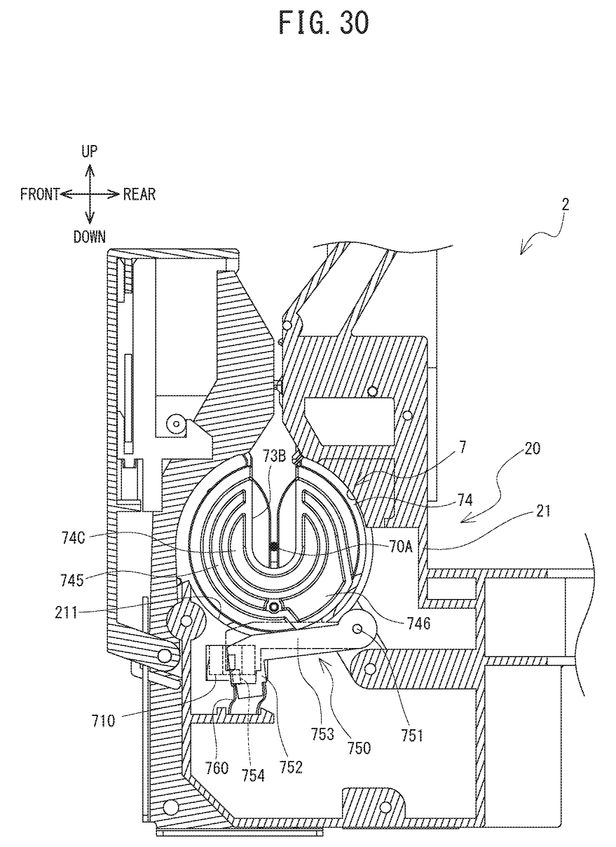

The label affixing device 1 detects the home position of the rotation body 70 as a result of the photosensor 701 detecting the detection plate 74A of the right side surface portion 74 of the rotation body 70 in the non-contact manner. The configuration is not limited to this example, and the label affixing device 1 may include a detection protruding portion 746 instead of the detection plate 74A. As shown in FIG. 30, the right side surface portion 74 of the rotation body 70 includes a detection base portion 745 further outward in the radial direction of the rotational axis center 70A than the rotation shaft portion 74C. The detection base portion 745 has a substantially C shape, protruding to the left along the peripheral direction excluding the insertion portion 73B, in a similar manner to the rotation shaft portion 74C. The detection base portion 745 includes the detection protruding portion 746 disposed at a part of the detection base portion 745 in the peripheral direction. The detection protruding portion 746 protrudes further outward in the radial direction of the rotational axis center 70A than the detection base portion 745.

The base body 20 of the main unit 2 includes a lever member 750 and a photosensor 710 in the bottom portion 21. The lever member 750 includes a support shaft 751 at a position diagonally downward and to the rear of the rotation body 70, at a position corresponding to an arrangement position of the detection base portion 745 in the left-right direction. The support shaft 751 is parallel to the rotational axis center 70A. The lever member 750 is rotatably supported by the support shaft 751.

The lever member 750 extends to the front from the support shaft 751, and a distal portion 752 is curved downward. Due to swinging of the lever member 750, the distal portion 752 moves in the up-down direction. The distal portion 752 is urged upward by a coil spring 760 disposed in the bottom portion 21. A detection protrusion 754 is provided at the left surface of the distal portion 752. The detection protrusion 754 protrudes to the left.

The photosensor 710 is disposed at a position corresponding to a movement range of the detection protrusion 754. The detection protrusion 754 passes between a light emitting portion and a light receiving portion of the photosensor 710. The lever member 750 includes an intermediate portion 753 between the distal portion 752 and the support shaft 751. The detection base portion 745 and the detection protruding portion 746 of the right side surface portion 74 come into contact with the intermediate portion 753 from above. Due to the urging of the coil spring 760, the lever member 750 is pressed in the clockwise direction with respect to the support shaft 751 in a right side view.

Depending on the rotation position of the rotation body 70, the detection base portion 745 or the detection protruding portion 746 comes into contact with the intermediate portion 753. At the rotation position of the rotation body 70 when the detection base portion 745 is in contact with the intermediate portion 753, the detection protrusion 754 is detected by the photosensor 710. Note that the state of the lever member 750 when the detection base portion 745 is in contact with the intermediate portion 753 is indicated by a single dot chain line in FIG. 30. At the rotation position of the rotation body 70 when the detection protruding portion 746 is in contact with the intermediate portion 753, the detection protrusion 754 is not detected by the photosensor 710. The controller may perform control of the rotation position of the rotation body 70 using a position at which the detection protrusion 754 is not detected by the photosensor 710 as the home position.

What is claimed is:

1. A label affixing device comprising:
a peeling member configured to peel a label from a long release material supporting the label to be affixed to an adherend;
a winding portion configured to wind the release material subsequent to the label being peeled therefrom by the peeling member; and
a first drive power source configured to generate a driving force to drive the winding portion, wherein
the winding portion includes
a reel configured to wind the release material onto an outer peripheral surface, the reel including an opening extending through the outer peripheral surface, and
a rotation shaft rotatably supporting the reel,
the reel further includes an advancing/retracting member configured to be movable between an extended position and a retracted position,
the extended position is a position where the advancing/retracting member is disposed inside the opening and where a shortest length in a peripheral direction of the outer peripheral surface at a section including the opening is a first peripheral length, and
the retracted position is a position where the advancing/retracting member retracts further inward in a radial direction than the extended position and where the shortest length in the peripheral direction is a second peripheral length shorter than the first peripheral length,
when the winding portion winds the release material, the advancing/retracting member is disposed at the extended position, and
when a roll on which the release material is wound is to be removed from the winding portion, the advancing/retracting member is disposed at the retracted position.

2. The label affixing device according to claim 1, wherein
the rotation shaft is supported at a housing at an end portion in one direction in an axial direction, and
the reel includes
an insertion slot open in the outer peripheral surface and into which an end portion of the release material is inserted, and
a removal opening open in a side surface in the other direction in the axial direction, and connected to the insertion slot.

3. The label affixing device according to claim 2, wherein
the reel includes an operation member including an operation portion and a first arrangement portion,
the operation portion is disposed at a side surface in the other direction in the axial direction, and is configured to move between a first position and a second position, and
the first arrangement portion is disposed inside the reel, connected to the operation portion, and configured to position the advancing/retracting member at the extended position and at the retracted position in accordance with a position of the operation portion, and
the first arrangement portion
positions the advancing/retracting member at the extended position when the operation portion is positioned at the first position, and
positions the advancing/retracting member at the retracted position when the operation portion is positioned at the second position.

4. The label affixing device according to claim 3, wherein
the operation portion of the operation member
is disposed overlapping with the removal opening in the axial direction when positioned at the first position, and
is disposed not overlapping with the removal opening in the axial direction when positioned at the second position.

5. The label affixing device according to claim 3, wherein
the reel includes a presser member including
a flexible portion configured to elastically deform, and
a presser portion connected to the flexible portion and having a plurality of teeth aligned in the axial direction,
the presser portion of the presser member is configured to be movable between
a contact position at which the plurality of teeth are in contact with an inner surface of the insertion slot, and
a separated position at which the plurality of teeth are separated from the inner surface of the insertion slot,
the operation member includes a second arrangement portion connected to the operation portion, and configured to position the presser portion of the presser member at the contact position and at the separated position in accordance with the position of the operation portion, and
the second arrangement portion
presses the flexible portion and positions the presser portion at the contact position when the operation portion is positioned at the first position, and
releases a pressing of the flexible portion and positions the presser portion at the separated position, using an urging force of the flexible portion, when the operation portion is positioned at the second position.

6. The label affixing device according to claim 5, wherein
the inner surface of the insertion slot includes a plurality of receiving teeth extending in a direction orthogonal to an insertion direction of the end portion of the release material, at a position at which the plurality of teeth of the presser portion come into contact therewith, and formed in a stepped shape in the insertion direction.

7. The label affixing device according to claim 6, wherein
the second arrangement portion is a cam member configured to rotate in accordance with operation of the operation portion, and cause the flexible portion to be in a state of releasing the pressing.

8. A label affixing device comprising:
a wrapping portion into which is inserted an adherend to which is affixed an end portion of a label being an affixing target, the wrapping portion being configured to rotate due to a driving force transmitted from a second drive power source and to wrap and affix the label around a periphery of the adherend; and
a housing configured to rotatably support the wrapping portion, wherein
the wrapping portion includes
a first pressing member including a first pressing surface, the first pressing surface being a flat surface along an insertion direction in which the adherend is inserted toward an insertion position of the adherend, and being oriented toward the insertion position in one direction, with respect to the insertion position, in a direction intersecting the insertion direction, the first pressing member using the first pressing surface to press the label toward the adherend when the adherend is positioned at the insertion position,
a second pressing member including a second pressing surface being a flat surface along the insertion direction, being oriented toward the insertion position in the other direction, with respect to the insertion position, in the direction intersecting the insertion direction, and facing the first pressing member, the second pressing member using the second pressing surface to press the label toward the adherend when the adherend is positioned at the insertion position,
a rotation body configured to internally hold the first pressing member and the second pressing member, and to rotate around the insertion position,
a first urging member disposed between an inner surface of the rotation body and the first pressing member, and configured to urge the first pressing member in a direction causing the first pressing surface to approach the second pressing surface with the insertion position interposed between the first pressing surface and the second pressing surface, and
a second urging member disposed between the inner surface of the rotation body and the second pressing member, and configured to urge the second pressing member in a direction causing the second pressing surface to approach the first pressing surface with the insertion position interposed between the first pressing surface and the second pressing surface.

9. The label affixing device according to claim 8, wherein
each of the first pressing member and the second pressing member has a plate shape extending along the insertion direction, and
the first pressing member and the second pressing member include
a single shaft body supporting, at the rotation body, each of base portions positioned further downstream than the insertion position in the insertion direction.

10. The label affixing device according to claim 9, wherein
each of distal portions positioned further upstream than the insertion position in the insertion direction, at end portions of the first pressing member and the second pressing member on opposite ends to each of the base portions, is positioned further inward than an outer periphery of the rotation body, regardless of a swinging position of the first pressing member and the second pressing member.

11. The label affixing device according to claim 10, further comprising:
a first detector configured to detect a presence or absence of the insertion of the adherend into the insertion position, at a position in one direction with respect to the rotation body in an axial direction, the axial direction being a direction in which a rotational axis center of the rotation body extends; and
a second detector configured to detect the presence or absence of the insertion of the adherend into the insertion position, at a position in the other direction with respect to the rotation body in the axial direction, wherein
when both the first detector and the second detector detect that the adherend has been inserted into the insertion position, the second drive power source is driven and rotates the rotation body.

12. The label affixing device according to claim 11, wherein
the first pressing surface and the second pressing surface each have a coating layer formed thereon to suppress attachment of adhesive.

13. The label affixing device according to claim 11, further comprising:
a first support member rotatably supporting one end of the rotation body in the axial direction, and including a first guide groove configured to guide the insertion of the adherend into the insertion position; and
a second support member rotatably supporting the other end of the rotation body in the axial direction, and including a second guide groove configured to guide the insertion of the adherend into the insertion position, wherein
the housing includes
a first fixing portion configured to fix the first support member in a state in which the first support member and the second support member are supporting the rotation body, and
a second fixing portion configured to fix the second support member in the state in which the first support member and the second support member are supporting the rotation body.

14. The label affixing device according to claim 13, wherein
the first guide groove has a recessed shape obtained by cutting out the first support member toward a first guide position guiding the adherend,
the second guide groove has a recessed shape obtained by cutting out the second support member toward a second guide position guiding the adherend, and
in the state in which the first support member and the second support member are supporting the rotation body, the first guide position and the second guide position are disposed at a same position as the insertion position in the axial direction of the rotation body.

15. The label affixing device according to claim 14, wherein
the rotation body includes
a first supported portion supported by the first support member at the one end in the axial direction, and
a second supported portion supported by the second support member at the other end in the axial direction, wherein
at the one end of the rotation body in the axial direction, the first supported portion protrudes further in the one direction in the axial direction than other portions, and
at the other end of the rotation body in the axial direction, the second supported portion protrudes further in the other direction in the axial direction than other portions.

16. The label affixing device according to claim 15, wherein
the housing includes a position detector configured to detect a rotation position of the rotation body.

17. The label affixing device according to claim 16, wherein
in an attachment direction of the rotation body to the housing, the position detector is disposed further to the rear than an attachment position of the rotation body in the housing.

18. The label affixing device according to claim 17, wherein
the first support member includes a first contact portion configured to come into contact with the adherend when the adherend is inserted into the insertion position, and a first transmission member configured to transmit to the first detector when the adherend is in contact with the first contact portion,
the second support member includes a second contact portion configured to come into contact with the adherend when the adherend is inserted into the insertion position, and a second transmission member configured to transmit to the second detector when the adherend is in contact with the second contact portion,
a detectable range of the first detector is wider than a contactable range of the adherend with the first contact portion, and
a detectable range of the second detector is wider than a contactable range of the adherend with the second contact portion.

19. The label affixing device according to claim 18, wherein
in a state in which the first support member and the second support member are not respectively fixed to the first fixing portion and the second fixing portion of the housing, the first support member and the second support member are rotatable with respect to the first fixing portion and the second fixing portion around the rotational axis center of the rotation body, and an orientation of the first support member and the second support member at a time of attaching to and removing from the housing is different from an orientation in a state in which the first support member and the second support member are respectively fixed to the first fixing portion and the second fixing portion.

20. The label affixing device according to claim 18, wherein
the first transmission member extends in a rod shape,
a first base end portion being one end of the first transmission member is rotatably supported by the first support member,
a first distal end portion being the other end of the first transmission member is disposed at a position higher than the first contact portion and transmits a detection result to the first detector by swinging,
the first contact portion is disposed between the first base end portion and the first distal end portion,
the second transmission member extends in a rod shape,
a second base end portion being one end of the second transmission member is rotatably supported by the second support member,
a second distal end portion being the other end of the second transmission member is disposed at a position higher than the second contact portion and transmits a detection result to the second detector by swinging, and
the second contact portion is disposed between the second base end portion and the second distal end portion.
